(19) United States
(12) Patent Application Publication
(10) Pub. No.: US 2025/0150896 A1
(43) Pub. Date: May 8, 2025

(54) ENCODERS AND DECODERS FOR VECTOR COMPRESSION

(71) Applicant: QUALCOMM Incorporated, San Diego, CA (US)

(72) Inventors: Pavan Kumar VITTHALADEVUNI, San Diego, CA (US); Naga BHUSHAN, San Diego, CA (US); Jay Kumar SUNDARARAJAN, San Diego, CA (US)

(21) Appl. No.: 18/919,398

(22) Filed: Oct. 17, 2024

Related U.S. Application Data
(60) Provisional application No. 63/595,658, filed on Nov. 2, 2023.

(51) Int. Cl. H04W 28/06

(52) U.S. Cl. CPC H04W 28/06

(57) ABSTRACT

Some examples of the techniques described herein may provide encoding or decoding approaches to generate vectors that meet an orthogonality condition in vector compression procedures (e.g., vector compression or decompression). Encoder layers (e.g., neural network layers) on the encode side may generate orthogonal compressed vectors or decoder layers (e.g., neural network layers) on the decode side may generate orthogonal decompressed vectors. For instance, a neural network layer may be trained to generate a compressed or decompressed vector that satisfies an orthogonality condition relative to one or more previously compressed or decompressed vectors in accordance with a dependency order or a compression sequence. An indication of the dependency order may be communicated between the encode side and the decode side to order encoder or decoder layers (e.g., to execute encoder or decoder layers in the compression sequence) to produce compressed or decompressed vectors that satisfy an orthogonality condition.

### CROSS REFERENCE

The present application for patent claims the benefit of U.S. Provisional Patent Application No. 63/595,658 by VITTHALADEVUNI et al., entitled “ENCODERS AND DECODERS FOR VECTOR COMPRESSION,” filed Nov. 2, 2023, assigned to the assignee hereof, and expressly incorporated by reference in its entirety herein.

### FIELD OF TECHNOLOGY

The following relates to wireless communications, including encoders and decoders for vector compression.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

Some examples of the techniques described herein may provide encoding or decoding approaches to generate vectors that meet an orthogonality condition in vector compression procedures (e.g., vector compression or decompression). Encoder layers (e.g., neural network layers) on the encode side may generate orthogonal compressed vectors or decoder layers (e.g., neural network layers) on the decode side may generate orthogonal decompressed vectors. For instance, a neural network layer may be trained to generate a compressed or decompressed vector that satisfies an orthogonality condition relative to one or more previously compressed or decompressed vectors in accordance with a dependency order or a compression sequence. An indication of the dependency order may be communicated between the encode side and the decode side to order encoder or decoder layers (e.g., to execute encoder or decoder layers in the compression sequence) to produce compressed or decompressed vectors that satisfy an orthogonality condition. Utilizing an encoder or decoder that satisfies the orthogonality condition may directly provide orthogonal vectors without resorting to an additional orthogonalization procedure.

A method by a first wireless device is described. The method may include communicating an indication of a dependency order for compression of a set of vectors, the dependency order being associated with a compression sequence for the set of vectors, encoding the set of vectors based on the dependency order and the compression sequence to generate a set of compressed vectors respectively corresponding to the set of vectors, and transmitting the set of compressed vectors.

A first wireless device is described. The first wireless device may include one or more memories storing processor executable code, and one or more processors coupled with the one or more memories. The one or more processors may individually or collectively operable to execute the code to cause the first wireless device to communicate an indication of a dependency order for compression of a set of vectors, the dependency order being associated with a compression sequence for the set of vectors, encode the set of vectors based on the dependency order and the compression sequence to generate a set of compressed vectors respectively corresponding to the set of vectors, and transmit the set of compressed vectors.

Another first wireless device is described. The first wireless device may include means for communicating an indication of a dependency order for compression of a set of vectors, the dependency order being associated with a compression sequence for the set of vectors, means for encoding the set of vectors based on the dependency order and the compression sequence to generate a set of compressed vectors respectively corresponding to the set of vectors, and means for transmitting the set of compressed vectors.

A non-transitory computer-readable medium storing code is described. The code may include instructions executable by a processor to communicate an indication of a dependency order for compression of a set of vectors, the dependency order being associated with a compression sequence for the set of vectors, encode the set of vectors based on the dependency order and the compression sequence to generate a set of compressed vectors respectively corresponding to the set of vectors, and transmit the set of compressed vectors.

In some examples of the method, first wireless devices, and non-transitory computer-readable medium described herein, communicating the indication of the dependency order may include operations, features, means, or instructions for transmitting the indication of the dependency order to a second wireless device in a message with the set of compressed vectors or in a message separate from the set of compressed vectors that may be transmitted with a same periodicity or a different periodicity as the set of compressed vectors.

In some examples of the method, first wireless devices, and non-transitory computer-readable medium described herein, communicating the indication of the dependency order may include operations, features, means, or instructions for receiving the indication of the dependency order from a second wireless device for configuring the first wireless device with the dependency order.

In some examples of the method, first wireless devices, and non-transitory computer-readable medium described herein, the indication of the dependency order for compression indicates at least one operational dependency in a set of encoder layers of the first wireless device or at least one operational dependency in a set of decoder layers of a second wireless device.

In some examples of the method, first wireless devices, and non-transitory computer-readable medium described herein, encoding the set of vectors may include operations, features, means, or instructions for encoding the set of vectors using a set of encoder layers according to the dependency order, where each encoder layer of the set of encoder layers, after an initial encoder layer, may be dependent on one or more compressed vectors respectively generated by one or more previous encoder layers of the set of encoder layers in the dependency order.

In some examples of the method, first wireless devices, and non-transitory computer-readable medium described herein, encoding the set of vectors may include operations, features, means, or instructions for encoding a first vector of the set of vectors using a first encoder layer of the set of encoder layers to generate a first compressed vector of the set of compressed vectors and encoding, based on the first compressed vector, a second vector of the set of vectors using a second encoder layer of the set of encoder layers, where the second encoder layer operates after the first encoder layer in the compression sequence, and where the second encoder layer may be dependent on the first compressed vector generated by the first encoder layer in the dependency order.

In some examples of the method, first wireless devices, and non-transitory computer-readable medium described herein, encoding the set of vectors may include operations, features, means, or instructions for encoding each vector of the set of vectors using a respective neural network layer of a set of neural network layers.

In some examples of the method, first wireless devices, and non-transitory computer-readable medium described herein, the set of neural network layers may be trained to generate compressed vectors in the set of compressed vectors that satisfy an orthogonality condition.

Some examples of the method, first wireless devices, and non-transitory computer-readable medium described herein may further include operations, features, means, or instructions for receiving a reference signal and performing a decomposition based on the reference signal to generate the set of vectors, where each vector in the set of vectors may be orthogonal with respect to at least one other vector in the set of vectors.

A method by a second wireless device is described. The method may include communicating an indication of a dependency order for compression of a set of vectors, the dependency order being associated with a compression sequence for the set of vectors, receiving a set of compressed vectors that is based on the set of vectors, and decoding the set of compressed vectors based on the dependency order and the compression sequence to generate a set of decompressed vectors respectively corresponding to the set of vectors.

A second wireless device is described. The second wireless device may include one or more memories storing processor executable code, and one or more processors coupled with the one or more memories. The one or more processors may individually or collectively operable to execute the code to cause the second wireless device to communicate an indication of a dependency order for compression of a set of vectors, the dependency order being associated with a compression sequence for the set of vectors, receive a set of compressed vectors that is based on the set of vectors, and decode the set of compressed vectors based on the dependency order and the compression sequence to generate a set of decompressed vectors respectively corresponding to the set of vectors.

Another second wireless device is described. The second wireless device may include means for communicating an indication of a dependency order for compression of a set of vectors, the dependency order being associated with a compression sequence for the set of vectors, means for receiving a set of compressed vectors that is based on the set of vectors, and means for decoding the set of compressed vectors based on the dependency order and the compression sequence to generate a set of decompressed vectors respectively corresponding to the set of vectors.

A non-transitory computer-readable medium storing code is described. The code may include instructions executable by a processor to communicate an indication of a dependency order for compression of a set of vectors, the dependency order being associated with a compression sequence for the set of vectors, receive a set of compressed vectors that is based on the set of vectors, and decode the set of compressed vectors based on the dependency order and the compression sequence to generate a set of decompressed vectors respectively corresponding to the set of vectors.

In some examples of the method, second wireless devices, and non-transitory computer-readable medium described herein, communicating the indication of the dependency order may include operations, features, means, or instructions for receiving the indication of the dependency order from a first wireless device in a message with the set of compressed vectors or in a message separate from the set of compressed vectors that may be received with a same periodicity or a different periodicity as the set of compressed vectors.

In some examples of the method, second wireless devices, and non-transitory computer-readable medium described herein, communicating the indication of the dependency order may include operations, features, means, or instructions for transmitting the indication of the dependency order to a first wireless device for configuring the first wireless device with the dependency order.

In some examples of the method, second wireless devices, and non-transitory computer-readable medium described herein, the indication of the dependency order for compression indicates at least one operational dependency in a set of encoder layers of a first wireless device or at least one operational dependency in a set of decoder layers of the second wireless device.

In some examples of the method, second wireless devices, and non-transitory computer-readable medium described herein, decoding the set of vectors may include operations, features, means, or instructions for decoding the set of vectors using a set of decoder layers according to the dependency order, where each decoder layer of the set of decoder layers, after an initial decoder layer, may be dependent on one or more decompressed vectors respectively generated by one or more previous decoder layers of the set of decoder layers in the dependency order.

In some examples of the method, second wireless devices, and non-transitory computer-readable medium described herein, decoding the set of vectors may include operations, features, means, or instructions for decoding a first compressed vector of the set of compressed vectors using a first decoder layer of the set of decoder layers to generate a first decompressed vector of the set of decompressed vectors and decoding, based on the first decompressed vector, a second decompressed vector of the set of decompressed vectors using a second decoder layer of the set of decoder layers, where the second decoder layer operates after the first decoder layer in the compression sequence, and where the second decoder layer may be dependent on the first decompressed vector generated by the first decoder layer in the dependency order.

In some examples of the method, second wireless devices, and non-transitory computer-readable medium described herein, decoding the set of vectors may include operations, features, means, or instructions for decoding each compressed vector of the set of compressed vectors using a respective neural network layer of a set of neural network layers.

In some examples of the method, second wireless devices, and non-transitory computer-readable medium described herein, the set of neural network layers may be trained to generate decompressed vectors in the set of decompressed vectors that satisfy an orthogonality condition.

### BRIEF DESCRIPTION OF THE DRAWINGS

FIG. 1 shows an example of a wireless communications system that supports encoders and decoders for vector compression in accordance with one or more aspects of the present disclosure.

FIG. 2 shows an example of a wireless communications system that supports encoders and decoders for vector compression in accordance with one or more aspects of the present disclosure.

FIG. 3 shows an example of an encoder that supports encoders and decoders for vector compression in accordance with one or more aspects of the present disclosure.

FIG. 4 shows an example of a decoder that supports encoders and decoders for vector compression in accordance with one or more aspects of the present disclosure.

FIG. 5 shows an example of a process flow that supports encoders and decoders for vector compression in accordance with one or more aspects of the present disclosure.

FIGS. 6 and 7 show block diagrams of devices that support encoders and decoders for vector compression in accordance with one or more aspects of the present disclosure.

FIG. 8 shows a block diagram of a communications manager that supports encoders and decoders for vector compression in accordance with one or more aspects of the present disclosure.

FIG. 9 shows a diagram of a system including a device that supports encoders and decoders for vector compression in accordance with one or more aspects of the present disclosure.

FIGS. 10 and 11 show block diagrams of devices that support encoders and decoders for vector compression in accordance with one or more aspects of the present disclosure.

FIG. 12 shows a block diagram of a communications manager that supports encoders and decoders for vector compression in accordance with one or more aspects of the present disclosure.

FIG. 13 shows a diagram of a system including a device that supports encoders and decoders for vector compression in accordance with one or more aspects of the present disclosure.

FIGS. 14 through 17 show flowcharts illustrating methods that support encoders and decoders for vector compression in accordance with one or more aspects of the present disclosure.

### DETAILED DESCRIPTION

Some wireless communication systems utilize reference signals (e.g., channel state information reference signals (CSI-RSs)) to characterize a communication channel between devices. For example, a network entity may transmit a reference signal to a user equipment (UE). The UE may perform a decomposition (e.g., singular value decomposition (SVD)) to produce a set of vectors associated with the channel. The set of vectors may be compressed to reduce signaling bandwidth. In some cases, compressing the set of vectors may cause the resultant set of compressed vectors to be non-orthogonal. For some approaches, the loss of orthogonality from the compression may degrade channel tuning performance on the decode side. One way to resolve the loss of orthogonality is to perform an additional orthogonalization procedure (e.g., Gram-Schmidt orthogonalization) at the decode side after vector reconstruction. The additional orthogonalization procedure may consume resources on the decode side or may incur processing latency.

Some examples of the techniques described herein may provide encoding or decoding approaches to generate vectors that meet an orthogonality condition in vector compression procedures (e.g., vector compression or decompression). Encoder layers (e.g., neural network layers) on the encode side may generate orthogonal compressed vectors or decoder layers (e.g., neural network layers) on the decode side may generate orthogonal decompressed vectors. For instance, a neural network layer may be trained to generate a compressed or decompressed vector that satisfies an orthogonality condition relative to one or more previously compressed or decompressed vectors in accordance with a dependency order or a compression sequence. An indication of the dependency order may be communicated between the encode side and the decode side to order encoder or decoder layers (e.g., to execute encoder or decoder layers in the compression sequence) to produce compressed or decompressed vectors that satisfy an orthogonality condition. Utilizing an encoder or decoder that satisfies the orthogonality condition may directly provide orthogonal vectors without resorting to an additional orthogonalization procedure.

Aspects of the disclosure are initially described in the context of wireless communications systems. Aspects of the disclosure are also illustrated by and described with reference to block diagrams of an encoder and a decoder. Aspects of the disclosure are additionally illustrated by and described with reference to a process flow diagram. Aspects of the disclosure are further illustrated by and described with reference to apparatus diagrams, system diagrams, and flowcharts that relate to encoders and decoders for vector compression.

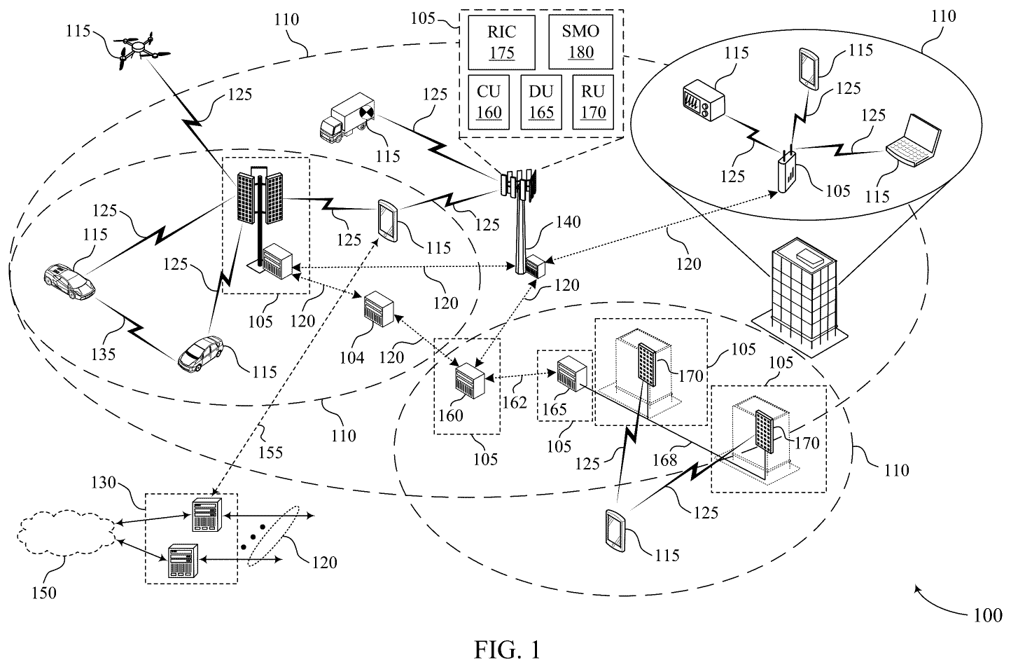

FIG. 1 shows an example of a wireless communications system 100 that supports encoders and decoders for vector compression in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support encoders and decoders for vector compression as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given RAT (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ns may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different RATs.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may utilize encoding (e.g., compression) to communicate vectors between wireless devices (e.g., between a UE 115 and a network entity 105). For example, the wireless communications system 100 may utilize reference signals (e.g., CSI-RSs or sounding reference signals (SRSs), among other examples) to characterize a communication channel between the wireless devices. For example, a network entity 105 may transmit a reference signal to a UE 115. The UE 15 may perform a decomposition (e.g., SVD) to produce a set of vectors associated with the channel. The set of vectors may be compressed to reduce signaling bandwidth. In some cases, compressing the set of vectors may cause the resultant set of compressed vectors to be non-orthogonal. For some approaches, the loss of orthogonality from the compression may degrade channel tuning performance on the decode side. One way to resolve the loss of orthogonality is to perform an additional orthogonalization procedure (e.g., Gram-Schmidt orthogonalization) at the decode side after vector reconstruction. The additional orthogonalization procedure may consume resources on the decode side or may incur processing latency.

Some examples of the techniques described herein may provide encoding or decoding approaches to generate vectors that meet an orthogonality condition in vector compression procedures (e.g., vector compression or decompression). Encoder layers (e.g., neural network layers) on the encode side may generate orthogonal compressed vectors or decoder layers (e.g., neural network layers) on the decode side may generate orthogonal decompressed vectors. For instance, a neural network layer may be trained to generate a compressed or decompressed vector that satisfies an orthogonality condition relative to one or more previously compressed or decompressed vectors in accordance with a dependency order or a compression sequence. An indication of the dependency order may be communicated between the encode side and the decode side to order encoder or decoder layers (e.g., to execute encoder or decoder layers in the compression sequence) to produce compressed or decompressed vectors that satisfy an orthogonality condition. Utilizing an encoder or decoder that satisfies the orthogonality condition may directly provide orthogonal vectors without resorting to an additional orthogonalization procedure.

Some of the techniques described herein may utilize one or more neural network architectures for frequency domain compression or decompression of a set of vectors (e.g., vectors of a channel estimate H or right singular vectors (V-vectors)). For instance, some of the techniques described herein may be utilized for H-in-H-out compression and decompression or V-in-V-out compression and decompression. In some examples of V-in-V-out approaches, layer-common or layer-specific architectures may be utilized. In layer-common architectures, one or more neural network layers may be shared between encoding layers. In layer-specific architectures, one or more neural network layers may be exclusive to respective encoding layers. Some examples of the techniques described herein may be utilized to avoid orthogonality loss in vector encoding or decoding for layer-specific architectures. Some examples of the techniques described may provide neural network decoders that output orthogonal vectors. By enabling orthogonalization in neural network design, performance of neural network-based channel compression may increase.

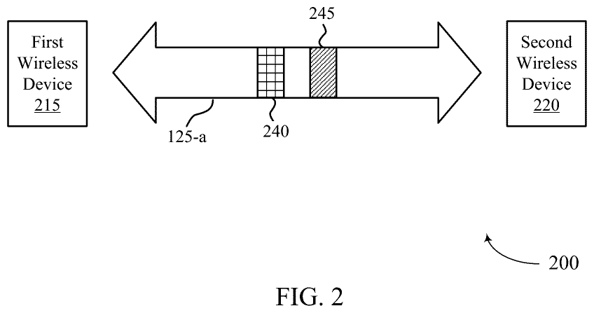

FIG. 2 shows an example of a wireless communications system 200 that supports encoders and decoders for vector compression in accordance with one or more aspects of the present disclosure. The wireless communications system 200 may implement aspects of or may be implemented by aspects of the wireless communications system 100. For instance, the wireless communications system 200 may include a first wireless device 215 and a second wireless device 220. In some aspects, the first wireless device 215 may be an example of a UE 115 as described with respect to FIG. 1 or the second wireless device 220 may be an example of a network entity 105 as described with respect to FIG. 1. In some aspects, the second wireless device 220 may be an example of a UE 115 as described with respect to FIG. 1 or the first wireless device 215 may be an example of a network entity 105 as described with respect to FIG. 1. In some aspects, the first wireless device 215 and the second wireless device 220 may be examples of a UE 115 as described with respect to FIG. 1. In some aspects, the first wireless device 215 and the second wireless device 220 may be examples of a network entity 105 as described with respect to FIG. 1.

The first wireless device 215 may communicate with the second wireless device 220 using a communication link 125-a, which may be an example of a communication link 125 described with respect to FIG. 1. The communication link 125-a may include a uni-directional or bi-directional link that enables uplink or downlink network communications, or that enables sidelink communications. For example, the first wireless device 215 may transmit one or more transmissions (e.g., uplink, downlink, or sidelink control signals or data signals), to the second wireless device 220 using the communication link 125-a, and the second wireless device 220 may transmit one or more transmissions (e.g., downlink, uplink, or sidelink control signals or data signals), to the first wireless device 215 using the communication link 125-a.

The first wireless device 215 or the second wireless device 220 may communicate an indication 245 of a dependency order for compression of a set of vectors. As used herein the term “communicate” and variations thereof may mean “transmit,” “receive,” or both. For example, the first wireless device 215 may transmit the indication 245 of the dependency order to the second wireless device 220, or the second wireless device 220 may transmit the indication 245 of the dependency order to the first wireless device 215 (which may receive the indication 245 of the dependency order, for instance). The indication 245 of the dependency order may be expressed as one or more indexes, identifiers, or implicit indications (e.g., an ordering of compressed vectors in a message).

In some examples, the set of vectors may be based on a reference signal. For example, the second wireless device 220 may transmit (or the first wireless device 215 may receive) a reference signal (e.g., a CSI-RS or an SRS, among other examples). The first wireless device 215 may perform a decomposition based on the reference signal to generate the set of vectors. For instance, the reference signal may be utilized to determine a channel estimate (e.g., H) of a channel via which the reference signal was communicated. In some examples, the set of vectors may be based on the channel estimate (e.g., may be vectors from the channel estimate or may be vectors derived from the channel estimate).

In some approaches, the first wireless device 215 may perform a decomposition (e.g., a SVD) to produce the set of vectors. For example, the set of vectors may be a set of right singular vectors (e.g., V-vectors) determined from the SVD of the channel estimate (e.g., determined from a subspace of the channel estimate, such as the SVD of a projection of the channel estimate in a DFT vector space). In some examples, each vector in the set of vectors may be orthogonal with respect to at least one other vector in the set of vectors. For example, each right singular vector from the SVD operation may be orthogonal with respect to each other right singular vector in the set of vectors.

The quantity of vectors may correspond to the rank of a matrix from the SVD operation. For instance, in a case that the first wireless device 215 has 4 antennas and the second wireless device 220 has 32 antennas, the channel estimate may have dimensions of 4×32. The SVD operation of the channel estimate (e.g., matrix) may produce 32 right singular vectors in this case, where the top or first 4 vectors may be included in the set of vectors because the channel estimate has a rank of 4. For example, a first column of a matrix from the SVD operation may be a first vector, a second column of the matrix may be a second vector, a third column of the matrix may be a third vector, and a fourth column may be a fourth vector. In some approaches, the order of the vectors may be ordered in terms of energy, where an initial vector has a highest energy and subsequent vectors have sequentially decreasing energies.

A dependency order for compression of a set of vectors may be an order (e.g., arrangement, progression, ranking, hierarchy, or sequence, among other examples) in which an encoder layer or a decoder layer depends or relies on another encoder layer or decoder layer for compressing or decompressing one or more vectors. The indication 245 of the dependency order for compression may indicate at least one operational dependency in a set of encoder layers of the first wireless device 215 or at least one operational dependency in a set of decoder layers of a second wireless device 220. For instance, a second encoder layer may depend on a first compressed vector generated by a first encoder layer to generate a second compressed vector. Additionally, or alternatively, a second decoder layer may depend on a first decompressed vector generated by a first decoder layer to generate a second decompressed vector. The dependency order may coincide, or may not coincide, with the order of vectors produced by the decomposition.

In some examples, the dependency order may be associated with a compression sequence for the set of vectors. The compression sequence may indicate a sequence in which the set of vectors may be compressed or decompressed. For instance, a first vector may be compressed initially to produce a first compressed vector. Subsequently, a second vector may be compressed to produce a second compressed vector (based on the first compressed vector, for example) in accordance with the compression sequence. Subsequently, a third vector may be compressed to produce a third compressed vector (based on the first compressed vector and the second compressed vector, for example) in accordance with the compression sequence. The compression sequence may coincide, or may not coincide, with the order of vectors produced by the decomposition.

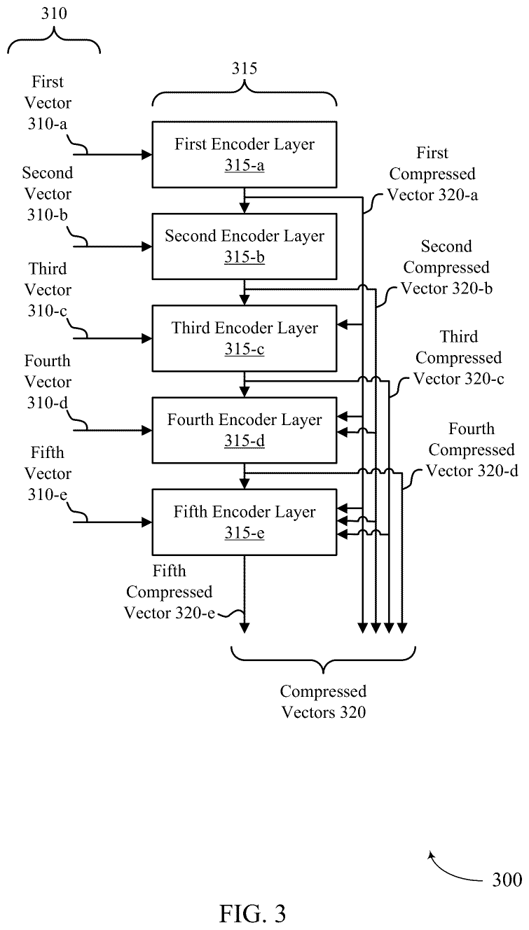

An encoder layer may be an encoder or a subset of an encoder for compressing a vector (e.g., a vector in the set of vectors). For example, an encoder layer may include a compressor (e.g., frequency-domain compressor) that utilizes an input vector to generate a compressed vector. In some approaches, an encoder layer may include a quantizer to quantize the vector or the compressed vector. An encoder layer may generate a compressed vector that is representative of the input vector. In some cases, an encoder layer may generate a compressed vector that satisfies an orthogonality condition between the compressed vector and one or more compressed vectors (if any) from one or more corresponding encoder layers (e.g., one or more compressed vectors from one or more previous or lower encoder layers). In an example, a second encoder layer may produce a second compressed vector that is representative of a second vector (e.g., second input vector) while satisfying an orthogonality condition relative to a first compressed vector from a first encoder layer. A third encoder layer may produce a third compressed vector that is representative of a third vector (e.g., third input vector) while satisfying an orthogonality condition relative to the first compressed vector from the first encoder layer and relative to the second compressed vector from the second encoder layer. The orthogonality condition may be a condition where vectors are orthogonal (with a dot product of 0, for example) or where the dot product of the vectors is less than a threshold quantity (e.g., 0.05 or another amount). An example of encoder layers is given with reference to FIG. 3.

In some examples, an encoder layer may be (or may include) a neural network or one or more neural network layers. For instance, a set of encoder layers may include a respective set of neural network layers. An encoder layer may share one or more neural network layers with another encoder layer, or an encoder layer may be separate from one or more neural network layers of another encoder layer (e.g., may not share a neural network layer with another encoder layer). The set of neural network layers may be layers of one or more neural networks.

In some examples, the set of neural network layers may be trained to generate compressed vectors (in a set of compressed vectors 240, for instance) that satisfy the orthogonality condition or that represent the input vectors with increased accuracy. For example, the one or more neural network layers of the set of neural network layers may be trained using one or more loss functions (e.g., a sine-based loss function, a cosine-based loss function, or a capacity-based loss function, among other examples), where loss is reduced for compressed vectors that satisfy the orthogonality condition relative to one or more input compressed vectors, or where loss is reduced for reduced deviation of the compressed vectors from an input vector.

In some approaches, the set of neural network layers may be trained using a training data set (e.g., ground truth). For example, the training data set may include input vectors (e.g., right singular vectors) and ground truth compressed vectors for training, where the ground truth compressed vectors are orthogonal to each other or represent the input vectors with increased accuracy (e.g., optimal accuracy, reduced or minimal error). During training, the loss function may indicate a difference or deviation between compressed vectors generated (e.g., inferred, predicted, or selected) by one or more encoder layers and the ground truth compressed vectors. The loss function may indicate a greater loss for non-orthogonal compressed vectors (e.g., compressed vectors that fail to satisfy the orthogonality condition) or compressed vectors that deviate from the ground truth compressed vectors. For instance, the loss function may penalize non-orthogonal compressed vectors or compressed vectors with increased deviation. One or more weights of the one or more neural network layers may be adjusted to reduce the loss indicated by the loss function. For example, a training procedure may be repeated to iteratively reduce the loss indicated by the loss function.

In some examples, the one or more neural network layers of the encoder layers and the one or more neural network layers of the decoder layers may be trained jointly or separately. In joint training, for instance, the neural network layers of the encoder layers and of the decoder layers may be jointly trained, where right singular vectors are utilized as input vectors and ground truth decompressed vectors are utilized for loss function evaluation. In separate training, the neural network layers of the encoder layers may be trained separately from the neural network layers of the decoder layers. In some approaches, the first wireless device 215 may train the neural network layers of the encoder layers. In some approaches, another device (e.g., the second wireless device 220) may train the neural network layers of the encoder layers or send a representation of (e.g., data indicating one or more weights or structures of) the neural network layers of the encoder layers. After the neural network layers are trained (e.g., during runtime), the neural network layers of the encoder layers may be executed for a set of vectors (e.g., right singular vectors or V-vectors) corresponding to a reference signal to generate compressed vectors that satisfy the orthogonality condition.

The first wireless device 215 may encode the set of vectors based on the dependency order and the compression sequence to generate a set of compressed vectors 240 respectively corresponding to the set of vectors. For example, the first wireless device 215 may execute the encoder layers (e.g., neural network layers of the encoder layers) in accordance with the dependency order and the compression sequence to supply one or more encoder layers (e.g., non-initial encoder layers) with one or more compressed vectors from one or more previous or lower encoder layers to generate the set of compressed vectors 240.

In some examples, the first wireless device 215 may encode the set of vectors using a set of encoder layers according to the dependency order. Each encoder layer of the set of encoder layers, after an initial encoder layer, may be dependent on one or more compressed vectors respectively generated by one or more previous encoder layers of the set of encoder layers in the dependency order. For instance, an encoder of the first wireless device 215 may have a cascaded structure, where each encoder layer after an initial encoder layer may depend on each compressed vector generated by each respective previous encoder layer. For example, the first wireless device 215 may encode a first vector of the set of vectors using a first encoder layer of the set of encoder layers to generate a first compressed vector of the set of compressed vectors 240. The first wireless device 215 may encode, based on the first compressed vector, a second vector of the set of vectors using a second encoder layer of the set of encoder layers. The second encoder layer may operate after the first encoder layer in the compression sequence, and the second encoder layer may be dependent on the first compressed vector generated by the first encoder layer in the dependency order. In some examples, encoding the set of vectors may include encoding each vector of the set of vectors using a respective neural network layer of a set of neural network layers as described herein.

The first wireless device 215 may transmit the set of compressed vectors 240. For example, the first wireless device 215 may transmit the set of compressed vectors 240 to the second wireless device 220 via a physical uplink shared channel (PUSCH).

In some examples, the first wireless device 215 may transmit the indication 245 of the dependency order to the second wireless device 220 in a message with the set of compressed vectors 240. For instance, the first wireless device 215 (e.g., a UE) may transmit the indication 245 of the dependency order with the set of compressed vectors 240 in a PUSCH message. In some examples, the first wireless device 215 may transmit the indication 245 of the dependency order to the second wireless device 220 in a message separate from the set of compressed vectors 240. For instance, the first wireless device 215 (e.g., a UE) may transmit the indication 245 of the dependency order via one or more of a medium access control-control element (MAC-CE) message, a physical uplink control channel (PUCCH), a PUSCH, or a higher-layer message (e.g., a message at a higher layer than a physical layer or than a MAC layer) separate from the set of compressed vectors 240.

In some examples, the first wireless device 215 may receive the indication 245 of the dependency order from the second wireless device 220 for configuring the first wireless device 215 with the dependency order. For instance, the second wireless device 220 may transmit the indication 245 of the dependency order via one or more of downlink control information (DCI), a physical downlink control channel (PDCCH), a physical downlink shared channel (PDSCH), or a higher layer message (e.g., a message at a higher layer than a physical layer or than a MAC layer).

In some examples, the indication 245 of the dependency order may be communicated (e.g., transmitted) with a same periodicity as a periodicity of the set of compressed vectors 240 or with a different periodicity as a periodicity of the set of compressed vectors 240. For instance, the first wireless device 215 or the second wireless device 220 may communicate (e.g., transmit or receive) the indication 245 of the dependency order for each communication of the set of compressed vectors 240 or with a different periodicity (e.g., less often than the set of compressed vectors 240, or when the dependency order is changed less often than the communication of the set of compressed vectors 240, among other examples).

The second wireless device 220 may receive the set of compressed vectors 240 that is based on the set of vectors. The second wireless device 220 may decode the set of compressed vectors 240 based on the dependency order and the compression sequence to generate a set of decompressed vectors respectively corresponding to the set of vectors as described herein. For example, the second wireless device 220 may decode the set of vectors using a set of decoder layers according to the dependency order.

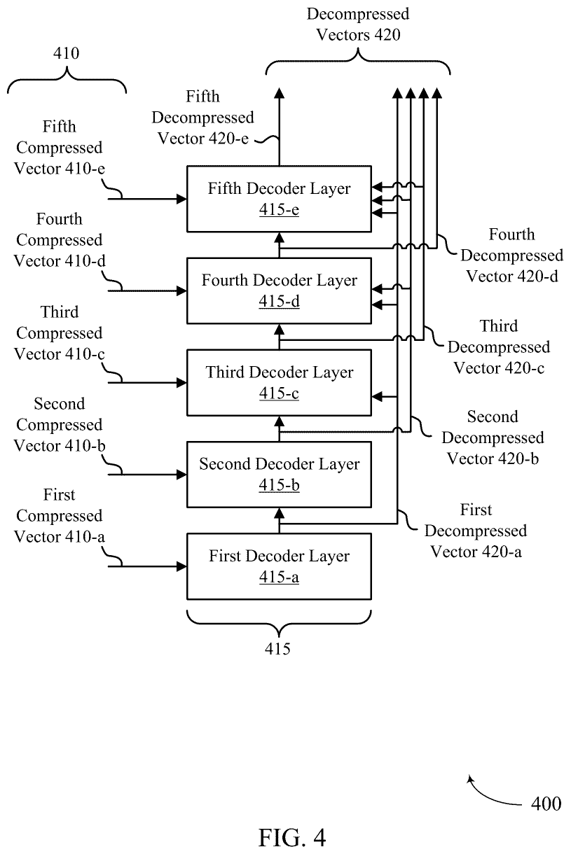

A decoder layer may be a decoder or a subset of a decoder for decompressing a compressed vector (e.g., a compressed vector in the set of compressed vectors). For example, a decoder layer may include a decompressor (e.g., frequency-domain decompressor) that utilizes an input compressed vector to generate a decompressed vector. In some approaches, a decoder layer may include a dequantizer to dequantize the vector or the decompressed vector. A decoder layer may generate a decompressed vector that is representative of the compressed vector or of an input vector before compression. In some cases, a decoder layer may generate a decompressed vector that satisfies an orthogonality condition between the decompressed vector and one or more decompressed vectors (if any) from one or more corresponding decoder layers (e.g., one or more decompressed vectors from one or more previous or lower decoder layers). In an example, a second decoder layer may produce a second decompressed vector that is representative of a second compressed vector (or a second vector before compression) while satisfying an orthogonality condition relative to a first decompressed vector from a first decoder layer. A third decoder layer may produce a third decompressed vector that is representative of a third compressed vector (or third vector before compression) while satisfying the orthogonality condition relative to the first decompressed vector from the first decoder layer and relative to the second decompressed vector from the second decoder layer. An example of decoder layers is given with reference to FIG. 4.

Each decoder layer of the set of decoder layers, after an initial decoder layer, may be dependent on one or more decompressed vectors respectively generated by one or more previous decoder layers of the set of decoder layers in the dependency order. For instance, a decoder of the second wireless device 220 may have a cascaded structure, where each decoder layer after an initial decoder layer may depend on each decompressed vector generated by each respective previous decoder layer. The second wireless device 220 may decode a first compressed vector of the set of compressed vectors 240 using a first decoder layer of the set of decoder layers to generate a first decompressed vector of the set of decompressed vectors. The second wireless device 220 may decode, based on the first decompressed vector, a second decompressed vector of the set of decompressed vectors using a second decoder layer of the set of decoder layers. The second decoder layer may operate after the first decoder layer in the compression sequence, and the second decoder layer may be dependent on the first decompressed vector generated by the first decoder layer in the dependency order.

In some examples, a set of compressed vectors 240 may be decompressed in accordance with the compression sequence. For instance, a first compressed vector may be decompressed initially to produce a first decompressed vector. Subsequently, a second compressed vector may be decompressed to produce a second decompressed vector (based on the first decompressed vector, for example) in accordance with the compression sequence. Subsequently, a third compressed vector may be decompressed to produce a third decompressed vector (based on the first decompressed vector and the second decompressed vector, for example) in accordance with the compression sequence.

In some examples, a decoder layer may be (or may include) a neural network or one or more neural network layers. For instance, a set of decoder layers may include a respective set of neural network layers. A decoder layer may share one or more neural network layers with another decoder layer, or a decoder layer may be separate from one or more neural network layers of another decoder layer (e.g., may not share a neural network layer with another decoder layer). The set of neural network layers may be layers of one or more neural networks.

In some examples, decoding the set of vectors may include decoding each compressed vector of the set of compressed vectors 240 using a respective neural network layer of a set of neural network layers as described herein. For instance, the set of neural network layers may be trained to generate decompressed vectors in the set of decompressed vectors that satisfy an orthogonality condition.

In some examples, the set of neural network layers may be trained to generate decompressed vectors (in a set of decompressed vectors, for instance) that satisfy the orthogonality condition or that represent the compressed vectors or input vectors (e.g., input vectors before compression) with increased accuracy. For example, the one or more neural network layers of the set of neural network layers may be trained using one or more loss functions (e.g., a sine-based loss function, a cosine-based loss function, or a capacity-based loss function, among other examples), where loss is reduced for decompressed vectors that satisfy the orthogonality condition relative to one or more other decompressed vectors, or where loss is reduced for reduced deviation of the decompressed vectors from a compressed vector or an input vector.

In some approaches, the set of neural network layers may be trained using a training data set (e.g., ground truth). For example, the training data set may include compressed vectors and ground truth decompressed vectors or ground truth input vectors (a set of vectors before compression) for training, where the ground truth decompressed vectors or ground truth input vectors are orthogonal from each other or represent the compressed vectors or input vectors with increased accuracy (e.g., optimal accuracy, reduced or minimal error). During training, the loss function may indicate a difference or deviation between decompressed vectors generated (e.g., inferred, predicted, or selected) by one or more decoder layers and the ground truth decompressed vectors or ground truth input vectors. The loss function may indicate a greater loss for non-orthogonal decompressed vectors (e.g., decompressed vectors that fail to satisfy the orthogonality condition) or decompressed vectors that deviate from the ground truth decompressed vectors or ground truth input vectors. For instance, the loss function may penalize non-orthogonal decompressed vectors or decompressed vectors with increased deviation. One or more weights of the one or more neural network layers may be adjusted to reduce the loss indicated by the loss function. For example, a training procedure may be repeated to iteratively reduce the loss indicated by the loss function. After the neural network layers are trained (e.g., during runtime), the neural network layers of the decoder layers may be executed for the compressed vectors 240 generated by an encoder to generate decompressed vectors that satisfy the orthogonality condition.

In some aspects, the second wireless device 220 may utilize the set of decompressed vectors. For example, the second wireless device 220 may adjust one or more communication parameters for communication with the first wireless device 215 based on the set of decompressed vectors. In some approaches, the second wireless device 220 may adjust transmit power for one or more antennas, phase for one or more antennas, beamforming, signal timing, or another communication parameter. For instance, the set of decompressed vectors may indicate one or more characteristics of the channel, and the second wireless device 220 may adjust one or more transmission parameters to compensate for characteristics of the channel or to adjust based on the characteristics of the channel.

FIG. 3 shows an example of an encoder 300 that supports encoders and decoders for vector compression in accordance with one or more aspects of the present disclosure. The wireless communications system 100 or the wireless communications system 200 may operate in accordance with one or more aspects of the encoder 300 in some approaches. For example, a UE 115 or a network entity 105 described with reference to FIG. 1 may include the encoder 300 or may operate the encoder 300. Additionally, or alternatively, the first wireless device 215 described with reference to FIG. 2 may include the encoder 300 or may operate the encoder 300.

In the example of FIG. 3, the encoder 300 includes a set of encoder layers 315: a first encoder layer 315-a, a second encoder layer 315-b, a third encoder layer 315-c, a fourth encoder layer 315-d, and a fifth encoder layer 315-e. While five encoder layers are provided in the example of FIG. 3 (and while other quantities of encoder layers are described in the examples herein), different quantities (e.g., 2, 3, 4, 10, 15, 30, among other examples) of encoder layers may be implemented in accordance with some examples of the techniques described herein. One or more of the encoder layers 315 described in the example of FIG. 3 may be examples of one or more of the encoder layers described with reference to FIG. 2. For instance, each of the encoder layers 315 may include one or more neural network layers trained to produce compressed vectors 320.

A set of vectors 310 is also illustrated in FIG. 3. The set of vectors 310 includes a first vector 310-a, a second vector 310-b, a third vector 310-c, a fourth vector 310-d, and a fifth vector 310-e. In some examples, the set of vectors 310 may be generated from a decomposition operation as described herein. While five vectors are provided in the example of FIG. 3 (and while other quantities of vectors are described in the examples herein), different quantities (e.g., 2, 3, 4, 10, 15, 30, among other examples) of vectors may be generated or utilized in accordance with some examples of the techniques described herein.

As illustrated in FIG. 3, the encoder 300 has a cascading structure and is structured in accordance with a dependency order. For example, an encoder layer with index “n” may operate on an input vector (e.g., V-vector) for layer “n,” and zero or more encoder outputs of the previous layers 0 through “n−1,” if any. For instance, the first encoder layer 315-a (n=0) operates on the first vector 310-a for the first encoder layer 315-a. Because there is no encoder layer previous to the first encoder layer 315-a, the first encoder layer 315-a operates on the first vector 310-a (and without any previous encoder output, for example) to generate a first compressed vector 320-a. The second encoder layer 315-b (n=1) operates on the second vector 310-b for the second encoder layer 315-b and depends on the first compressed vector 320-a generated by the first encoder layer 315-a (n=0) to generate a second compressed vector 320-b.

The third encoder layer 315-c, the fourth encoder layer 315-d, and the fifth encoder layer 315-e each depend on previous encoder layers in accordance with the dependency order. For example, the third encoder layer 315-c generates a third compressed vector 320-c based on the third vector 310-c, the first compressed vector 320-a, and the second compressed vector 320-b. The fourth encoder layer 315-d generates a fourth compressed vector 320-d based on the fourth vector 310-d, the first compressed vector 320-a, the second compressed vector 320-b, and the third compressed vector 320-c. The fifth encoder layer 315-e generates a fifth compressed vector 320-e based on the fifth vector 310-e, the first compressed vector 320-a, the second compressed vector 320-b, the third compressed vector 320-c, and the fourth compressed vector 320-d.

The encoder layers 315 may operate in accordance with a compression sequence. For example, the first encoder layer 315-a may operate before the second encoder layer 315-b, which may operate before the third encoder layer 315-c, which may operate before the fourth encoder layer 315-d, which may operate before the fifth encoder layer 315-e to generate the compressed vectors 320.

In some examples, each of the compressed vectors 320 may satisfy an orthogonality condition relative to one or more (e.g., all) of the other generated compressed vectors 320. For example, the fifth compressed vector 320-e may be orthogonal relative to the first compressed vector 320-a, the second compressed vector 320-b, the third compressed vector 320-c, and the fourth compressed vector 320-d.

The compressed vectors 320 (e.g., the encoder layer outputs) may be provided to (e.g., transmitted to) a decoder. For example, the compressed vectors 320 may be transmitted from the first wireless device 215 that may include the encoder 300 to the second wireless device 220 that may include a decoder. In some examples, the encoder 300 (or the first wireless device 215 that may include the encoder 300) may generate or send an indication of the dependency order to a decoder. For instance, the indication of the dependency order (or of the associated compression sequence) may be transmitted from the first wireless device 215 that may include the encoder 300 to the second wireless device 220 that may include a decoder. The indication of the dependency order may indicate indexes of the encoder layers 315, identifiers of the encoder layers 315, or an implicit indication of the encoder layers 315 (e.g., the second compressed vector 320-b may be sent after the first compressed vector 320-a in a message, indicating that the second compressed vector 320-b depends on a first decompressed vector (to be generated by a first decoder layer in an ordered set of decoder layers) based on the first compressed vector 320-a and so on for an ordered set of decoder layers).

FIG. 4 shows an example of a decoder 400 that supports encoders and decoders for vector compression in accordance with one or more aspects of the present disclosure. The wireless communications system 100 or the wireless communications system 200 may operate in accordance with one or more aspects of the decoder 400 in some approaches. For example, a UE 115 or a network entity 105 described with reference to FIG. 1 may include the decoder 400 or may operate the decoder 400. Additionally, or alternatively, the second wireless device 220 described with reference to FIG. 2 may include the decoder 400 or may operate the decoder 400.

In the example of FIG. 4, the decoder 400 includes a set of decoder layers 415: a first decoder layer 415-a, a second decoder layer 415-b, a third decoder layer 415-c, a fourth decoder layer 415-d, and a fifth decoder layer 415-e. While five decoder layers are provided in the example of FIG. 4 (and while other quantities of decoder layers are described in the examples herein), different quantities (e.g., 2, 4, 4, 10, 15, 40, among other examples) of decoder layers may be implemented in accordance with some examples of the techniques described herein. One or more of the decoder layers 415 described in the example of FIG. 4 may be examples of one or more of the decoder layers described with reference to FIG. 2. For instance, each of the decoder layers 415 may include one or more neural network layers trained to produce decompressed vectors 420.

A set of compressed vectors 410 is also illustrated in FIG. 4. The set of compressed vectors 410 includes a first compressed vector 410-a, a second compressed vector 410-b, a third compressed vector 410-c, a fourth compressed vector 410-d, and a fifth compressed vector 410-e. In some examples, the set of compressed vectors 410 may be received or obtained from an encoder (e.g., compressed vectors 320 may be received from the first wireless device 215) as described herein. While five compressed vectors are provided in the example of FIG. 4 (and while other quantities of compressed vectors are described in the examples herein), different quantities (e.g., 2, 4, 4, 10, 15, 40, among other examples) of compressed vectors may be generated or utilized in accordance with some examples of the techniques described herein.

As illustrated in FIG. 4, the decoder 400 has a cascading structure and is structured in accordance with a dependency order. For example, a decoder layer with index “n” may operate on an encoder output (e.g., compressed vector) for layer “n,” and zero or more decoder outputs of the previous layers 0 through “n−1,” if any. For instance, the first decoder layer 415-a (n=0) operates on the first compressed vector 410-a for the first decoder layer 415-a. Because there is no decoder layer previous to the first decoder layer 415-a, the first decoder layer 415-a operates on the first compressed vector 410-a (and without any previous decoder output, for example) to generate a first decompressed vector 420-a. The second decoder layer 415-b (n=1) operates on the second compressed vector 410-b for the second decoder layer 415-b and depends on the first decompressed vector 420-a generated by the first decoder layer 415-a (n=0) to generate a second decompressed vector 420-b.

The third decoder layer 415-c, the fourth decoder layer 415-d, and the fifth decoder layer 415-e each depend on previous decoder layers in accordance with the dependency order. For example, the third decoder layer 415-c generates a third decompressed vector 420-c based on the third compressed vector 410-c, the first decompressed vector 420-a, and the second decompressed vector 420-b. The fourth decoder layer 415-d generates a fourth decompressed vector 420-d based on the fourth compressed vector 410-d, the first decompressed vector 420-a, the second decompressed vector 420-b, and the third decompressed vector 420-c. The fifth decoder layer 415-e generates a fifth decompressed vector 420-e based on the fifth compressed vector 410-e, the first decompressed vector 420-a, the second decompressed vector 420-b, the third decompressed vector 420-c, and the fourth decompressed vector 420-d.

The decoder layers 415 may operate in accordance with a decompression sequence. For example, the first decoder layer 415-a may operate before the second decoder layer 415-b, which may operate before the third decoder layer 415-c, which may operate before the fourth decoder layer 415-d, which may operate before the fifth decoder layer 415-e to generate the decompressed vectors 420.

In some examples, each of the decompressed vectors 420 may satisfy an orthogonality condition relative to one or more (e.g., all) of the other generated decompressed vectors 420. For example, the fifth decompressed vector 420-e may be orthogonal relative to the first decompressed vector 420-a, the second decompressed vector 420-b, the third decompressed vector 420-c, and the fourth decompressed vector 420-d.

In some examples, the decompressed vectors 420 (e.g., the decoder layer outputs) may be utilized to control one or more communication parameters (e.g., transmission or reception parameters) to compensate for characteristics of the channel or to adjust based on the characteristics of the channel for one or more subsequent communications. For example, the second wireless device 220 may adjust transmit power for one or more antennas, phase for one or more antennas, beamforming, signal timing, or another communication parameter.

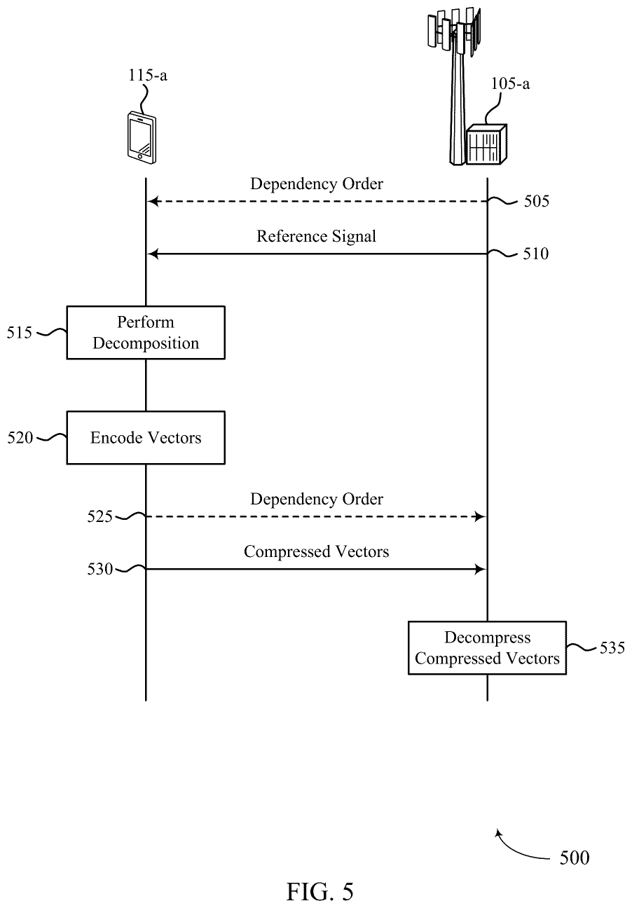

FIG. 5 shows an example of a process flow 500 that supports encoders and decoders for vector compression in accordance with one or more aspects of the present disclosure. A wireless communication system may include a UE 115-a and a network entity 105-a. The UE 115-a may be an example of the UEs 115 or the first wireless device 215, and the network entity 105-a may be an example of the network entities 105 or the second wireless device 220, as described herein.

In the following description of the process flow 500, the communications between the network entity 105-a and the UE 115-a may be transmitted in a different order than the example order shown, or the operations performed by the network entity 105-a and the UE 115-a may be performed in different orders or at different times. Some operations may be omitted from the process flow 500, or other operations may be added to the process flow 500. Further, although some operations or signaling may be shown to occur at different times for discussion purposes, these operations may actually occur at the same time or in overlapping time periods in some examples.

At 505, the network entity 105-a may transmit an indication of a dependency order to the UE 115-a. For example, the network entity 105-a may transmit the indication via DCI, PDCCH, or other signaling indicating the dependency order to the UE 115-a as described with reference to FIG. 2.

At 510, the network entity 105-a may transmit a reference signal to the UE 115-a. For example, the network entity 105-a may transmit CSI-RS to the UE 115-a as described with reference to FIG. 2.

At 515, the UE 115-a may perform a decomposition based on the reference signal. For example, the UE 115-a may perform SVD based on a channel estimate determined from the reference signal as described with reference to FIG. 2. Performing the decomposition may generate a set of vectors.

At 520, the UE 115-a may encode (e.g., compress) the set of vectors. For example, the UE 115-a may encode the set of vectors using a set of encoder layers (e.g., neural network layers) in accordance with a dependency order and a compression sequence as described with reference to FIG. 2. In some examples, the UE 115-a may utilize an indication of the dependency order received from the network entity 105-a to perform the encoding. In some examples, the UE 115-a may determine or utilize a dependency order to perform the encoding without an indication of the dependency order from the network entity 105-a.

At 525, the UE 115-a may transmit an indication of the dependency order 525 to the network entity 105-a. For example, the UE 115-a may transmit the indication via a PUSCH, PUCCH, MAC CE, or other signaling as described with reference to FIG. 2. In some examples, the UE 115-a or the network entity 105-a may transmit the indication of the dependency order to coordinate encoding or decoding. Because the encoder or decoder architecture may depend on an encoding or decoding dependency order (e.g., compression sequence), the dependency order (e.g., compression sequence) may be communicated between an encoder and a decoder.

In some approaches, an indication of a dependency order may be communicated in addition to, or alternatively from, other information. For example, a priority may be assigned to each non-zero coefficient based on a layer index on a spatial domain basis or a frequency domain basis. Each coefficient may be associated with a layer. In addition to information about layer compression communicated to the network entity 105-a, the UE 115-a may send an indication of a dependency order (e.g., an order in which compression is performed or the dependency of the decoder for a layer “n”).

At 530, the UE 115-a may transmit a set of compressed vectors to the network entity 105-a. For example, the UE 115-a may transmit the set of compressed vectors via a PUSCH as described with reference to FIG. 2.

At 535, the network entity 105-a may decode (e.g., decompress) the set of compressed vectors. For example, the network entity 105-a may decode the set of compressed vectors using a set of decoder layers (e.g., neural network layers) in accordance with a dependency order and a compression sequence as described with reference to FIG. 2. In some examples, the network entity 105-a may utilize an indication of the dependency order received from the UE 115-a to perform the decoding. In some examples, the network entity 105-a may utilize the set of decompressed vectors to control one or more communication parameters as described herein.

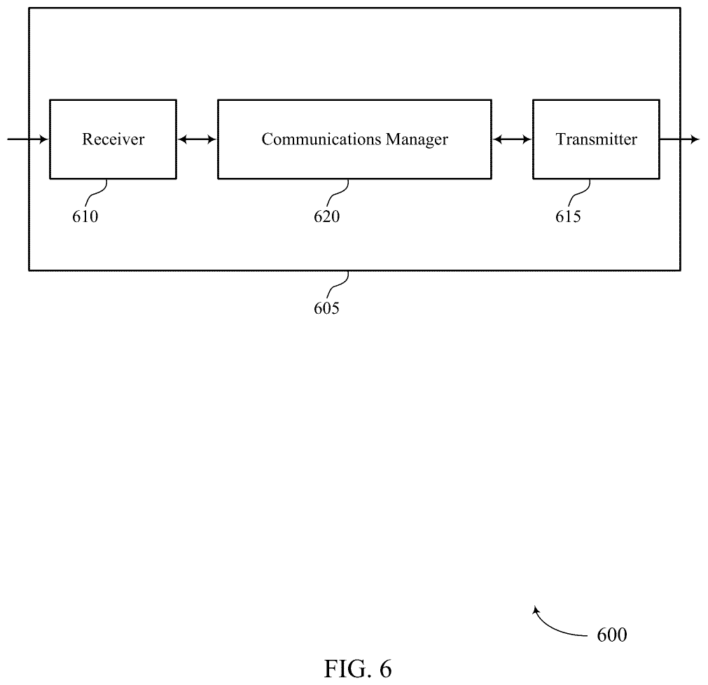

FIG. 6 shows a block diagram 600 of a device 605 that supports encoders and decoders for vector compression in accordance with one or more aspects of the present disclosure. The device 605 may be an example of aspects of a first wireless device as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to encoders and decoders for vector compression). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to encoders and decoders for vector compression). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of encoders and decoders for vector compression as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 is capable of, configured to, or operable to support a means for communicating an indication of a dependency order for compression of a set of vectors, the dependency order being associated with a compression sequence for the set of vectors. The communications manager 620 is capable of, configured to, or operable to support a means for encoding the set of vectors based on the dependency order and the compression sequence to generate a set of compressed vectors respectively corresponding to the set of vectors. The communications manager 620 is capable of, configured to, or operable to support a means for transmitting the set of compressed vectors.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, or more efficient utilization of communication resources.

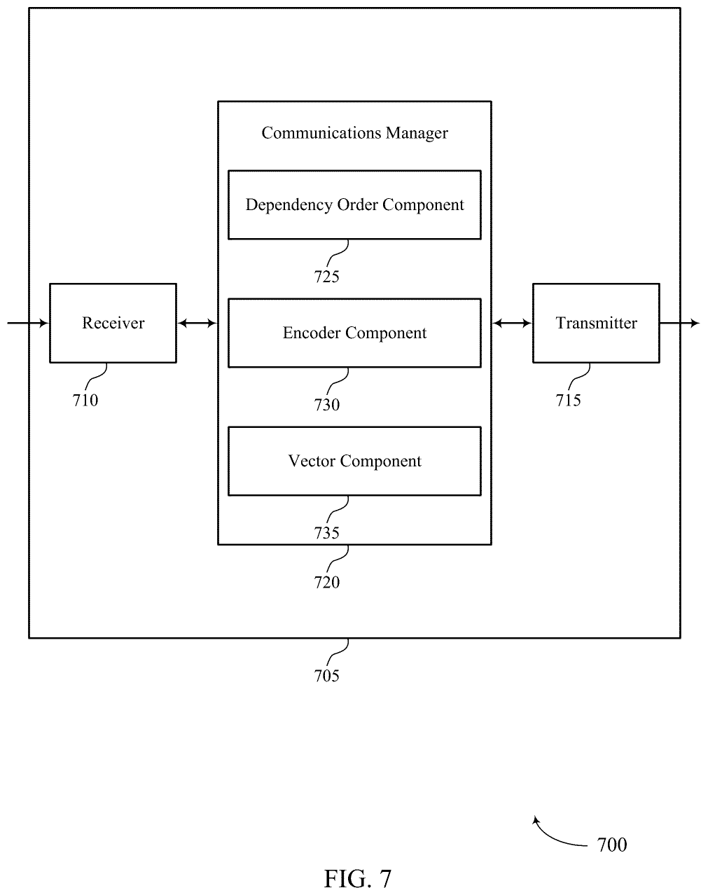

FIG. 7 shows a block diagram 700 of a device 705 that supports encoders and decoders for vector compression in accordance with one or more aspects of the present disclosure. The device 705 may be an example of aspects of a device 605 or a first wireless device as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to encoders and decoders for vector compression). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to encoders and decoders for vector compression). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of encoders and decoders for vector compression as described herein. For example, the communications manager 720 may include a dependency order component 725, an encoder component 730, a vector component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The dependency order component 725 is capable of, configured to, or operable to support a means for communicating an indication of a dependency order for compression of a set of vectors, the dependency order being associated with a compression sequence for the set of vectors. The encoder component 730 is capable of, configured to, or operable to support a means for encoding the set of vectors based on the dependency order and the compression sequence to generate a set of compressed vectors respectively corresponding to the set of vectors. The vector component 735 is capable of, configured to, or operable to support a means for transmitting the set of compressed vectors.

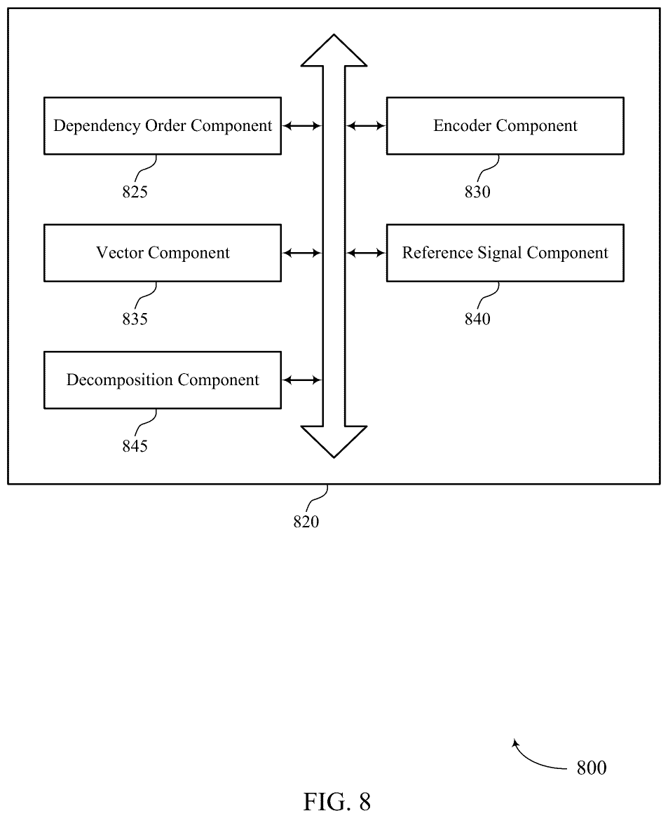

FIG. 8 shows a block diagram 800 of a communications manager 820 that supports encoders and decoders for vector compression in accordance with one or more aspects of the present disclosure. The communications manager 820 may be an example of aspects of a communications manager 620, a communications manager 720, or both, as described herein. The communications manager 820, or various components thereof, may be an example of means for performing various aspects of encoders and decoders for vector compression as described herein. For example, the communications manager 820 may include a dependency order component 825, an encoder component 830, a vector component 835, a reference signal component 840, a decomposition component 845, or any combination thereof. Each of these components, or components or subcomponents thereof (e.g., one or more processors, one or more memories), may communicate, directly or indirectly, with one another (e.g., via one or more buses).

The dependency order component 825 is capable of, configured to, or operable to support a means for communicating an indication of a dependency order for compression of a set of vectors, the dependency order being associated with a compression sequence for the set of vectors. The encoder component 830 is capable of, configured to, or operable to support a means for encoding the set of vectors based on the dependency order and the compression sequence to generate a set of compressed vectors respectively corresponding to the set of vectors. The vector component 835 is capable of, configured to, or operable to support a means for transmitting the set of compressed vectors.

In some examples, to support communicating the indication of the dependency order, the dependency order component 825 is capable of, configured to, or operable to support a means for transmitting the indication of the dependency order to a second wireless device in a message with the set of compressed vectors or in a message separate from the set of compressed vectors that is transmitted with a same periodicity or a different periodicity as the set of compressed vectors.

In some examples, to support communicating the indication of the dependency order, the dependency order component 825 is capable of, configured to, or operable to support a means for receiving the indication of the dependency order from a second wireless device for configuring the first wireless device with the dependency order.

In some examples, the indication of the dependency order for compression indicates at least one operational dependency in a set of encoder layers of the first wireless device or at least one operational dependency in a set of decoder layers of a second wireless device.

In some examples, to support encoding the set of vectors, the encoder component 830 is capable of, configured to, or operable to support a means for encoding the set of vectors using a set of encoder layers according to the dependency order, where each encoder layer of the set of encoder layers, after an initial encoder layer, is dependent on one or more compressed vectors respectively generated by one or more previous encoder layers of the set of encoder layers in the dependency order.

In some examples, to support encoding the set of vectors, the encoder component 830 is capable of, configured to, or operable to support a means for encoding a first vector of the set of vectors using a first encoder layer of the set of encoder layers to generate a first compressed vector of the set of compressed vectors. In some examples, to support encoding the set of vectors, the encoder component 830 is capable of, configured to, or operable to support a means for encoding, based on the first compressed vector, a second vector of the set of vectors using a second encoder layer of the set of encoder layers, where the second encoder layer operates after the first encoder layer in the compression sequence, and where the second encoder layer is dependent on the first compressed vector generated by the first encoder layer in the dependency order.

In some examples, to support encoding the set of vectors, the encoder component 830 is capable of, configured to, or operable to support a means for encoding each vector of the set of vectors using a respective neural network layer of a set of neural network layers.

In some examples, the set of neural network layers is trained to generate compressed vectors in the set of compressed vectors that satisfy an orthogonality condition.

In some examples, the reference signal component 840 is capable of, configured to, or operable to support a means for receiving a reference signal. In some examples, the decomposition component 845 is capable of, configured to, or operable to support a means for performing a decomposition based on the reference signal to generate the set of vectors, where each vector in the set of vectors is orthogonal with respect to at least one other vector in the set of vectors.

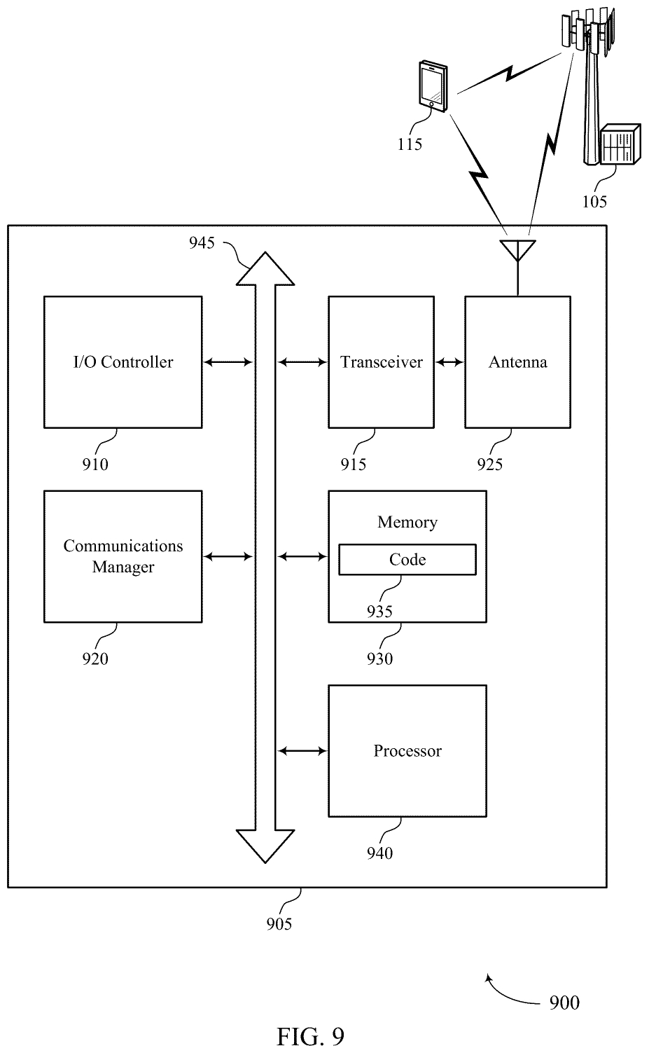

FIG. 9 shows a diagram of a system 900 including a device 905 that supports encoders and decoders for vector compression in accordance with one or more aspects of the present disclosure. The device 905 may be an example of or include the components of a device 605, a device 705, or a first wireless device as described herein. The device 905 may include components for bi-directional voice and data communications including components for transmitting and receiving communications, such as a communications manager 920, an I/O controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include RAM and ROM. The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a BIOS which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting encoders and decoders for vector compression). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

For example, the communications manager 920 is capable of, configured to, or operable to support a means for communicating an indication of a dependency order for compression of a set of vectors, the dependency order being associated with a compression sequence for the set of vectors. The communications manager 920 is capable of, configured to, or operable to support a means for encoding the set of vectors based on the dependency order and the compression sequence to generate a set of compressed vectors respectively corresponding to the set of vectors. The communications manager 920 is capable of, configured to, or operable to support a means for transmitting the set of compressed vectors.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of encoders and decoders for vector compression as described herein, or the at least one processor 940 and the at least one memory 930 may be otherwise configured to, individually or collectively, perform or support such operations.

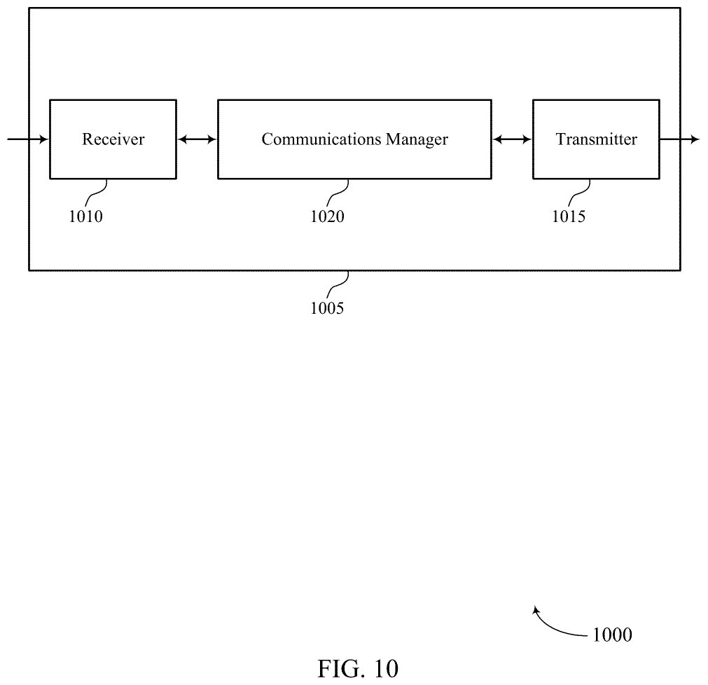

FIG. 10 shows a block diagram 1000 of a device 1005 that supports encoders and decoders for vector compression in accordance with one or more aspects of the present disclosure. The device 1005 may be an example of aspects of a second wireless device as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of encoders and decoders for vector compression as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

For example, the communications manager 1020 is capable of, configured to, or operable to support a means for communicating an indication of a dependency order for compression of a set of vectors, the dependency order being associated with a compression sequence for the set of vectors. The communications manager 1020 is capable of, configured to, or operable to support a means for receiving a set of compressed vectors that is based on the set of vectors. The communications manager 1020 is capable of, configured to, or operable to support a means for decoding the set of compressed vectors based on the dependency order and the compression sequence to generate a set of decompressed vectors respectively corresponding to the set of vectors.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, more efficient utilization of communication resources.

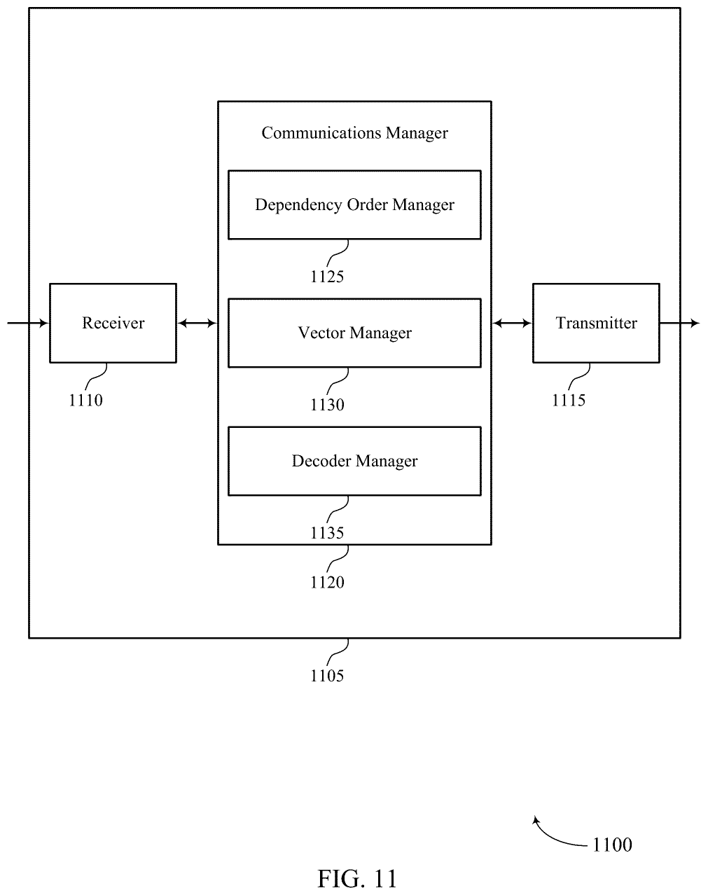

FIG. 11 shows a block diagram 1100 of a device 1105 that supports encoders and decoders for vector compression in accordance with one or more aspects of the present disclosure. The device 1105 may be an example of aspects of a device 1005 or a second wireless device as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of encoders and decoders for vector compression as described herein. For example, the communications manager 1120 may include a dependency order manager 1125, a vector manager 1130, a decoder manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The dependency order manager 1125 is capable of, configured to, or operable to support a means for communicating an indication of a dependency order for compression of a set of vectors, the dependency order being associated with a compression sequence for the set of vectors. The vector manager 1130 is capable of, configured to, or operable to support a means for receiving a set of compressed vectors that is based on the set of vectors. The decoder manager 1135 is capable of, configured to, or operable to support a means for decoding the set of compressed vectors based on the dependency order and the compression sequence to generate a set of decompressed vectors respectively corresponding to the set of vectors.

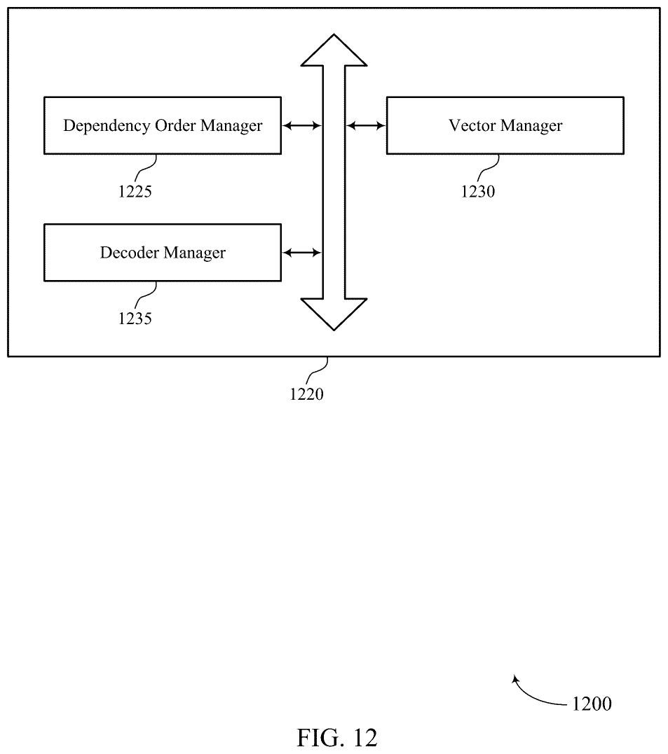

FIG. 12 shows a block diagram 1200 of a communications manager 1220 that supports encoders and decoders for vector compression in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of encoders and decoders for vector compression as described herein. For example, the communications manager 1220 may include a dependency order manager 1225, a vector manager 1230, a decoder manager 1235, or any combination thereof. Each of these components, or components or subcomponents thereof (e.g., one or more processors, one or more memories), may communicate, directly or indirectly, with one another (e.g., via one or more buses).

The dependency order manager 1225 is capable of, configured to, or operable to support a means for communicating an indication of a dependency order for compression of a set of vectors, the dependency order being associated with a compression sequence for the set of vectors. The vector manager 1230 is capable of, configured to, or operable to support a means for receiving a set of compressed vectors that is based on the set of vectors. The decoder manager 1235 is capable of, configured to, or operable to support a means for decoding the set of compressed vectors based on the dependency order and the compression sequence to generate a set of decompressed vectors respectively corresponding to the set of vectors.

In some examples, to support communicating the indication of the dependency order, the dependency order manager 1225 is capable of, configured to, or operable to support a means for receiving the indication of the dependency order from a first wireless device in a message with the set of compressed vectors or in a message separate from the set of compressed vectors that is received with a same periodicity or a different periodicity as the set of compressed vectors.

In some examples, to support communicating the indication of the dependency order, the dependency order manager 1225 is capable of, configured to, or operable to support a means for transmitting the indication of the dependency order to a first wireless device for configuring the first wireless device with the dependency order.

In some examples, the indication of the dependency order for compression indicates at least one operational dependency in a set of encoder layers of a first wireless device or at least one operational dependency in a set of decoder layers of the second wireless device.

In some examples, to support decoding the set of vectors, the decoder manager 1235 is capable of, configured to, or operable to support a means for decoding the set of vectors using a set of decoder layers according to the dependency order, where each decoder layer of the set of decoder layers, after an initial decoder layer, is dependent on one or more decompressed vectors respectively generated by one or more previous decoder layers of the set of decoder layers in the dependency order.

In some examples, to support decoding the set of vectors, the decoder manager 1235 is capable of, configured to, or operable to support a means for decoding a first compressed vector of the set of compressed vectors using a first decoder layer of the set of decoder layers to generate a first decompressed vector of the set of decompressed vectors. In some examples, to support decoding the set of vectors, the decoder manager 1235 is capable of, configured to, or operable to support a means for decoding, based on the first decompressed vector, a second decompressed vector of the set of decompressed vectors using a second decoder layer of the set of decoder layers, where the second decoder layer operates after the first decoder layer in the compression sequence, and where the second decoder layer is dependent on the first decompressed vector generated by the first decoder layer in the dependency order.

In some examples, to support decoding the set of vectors, the decoder manager 1235 is capable of, configured to, or operable to support a means for decoding each compressed vector of the set of compressed vectors using a respective neural network layer of a set of neural network layers.

In some examples, the set of neural network layers is trained to generate decompressed vectors in the set of decompressed vectors that satisfy an orthogonality condition.

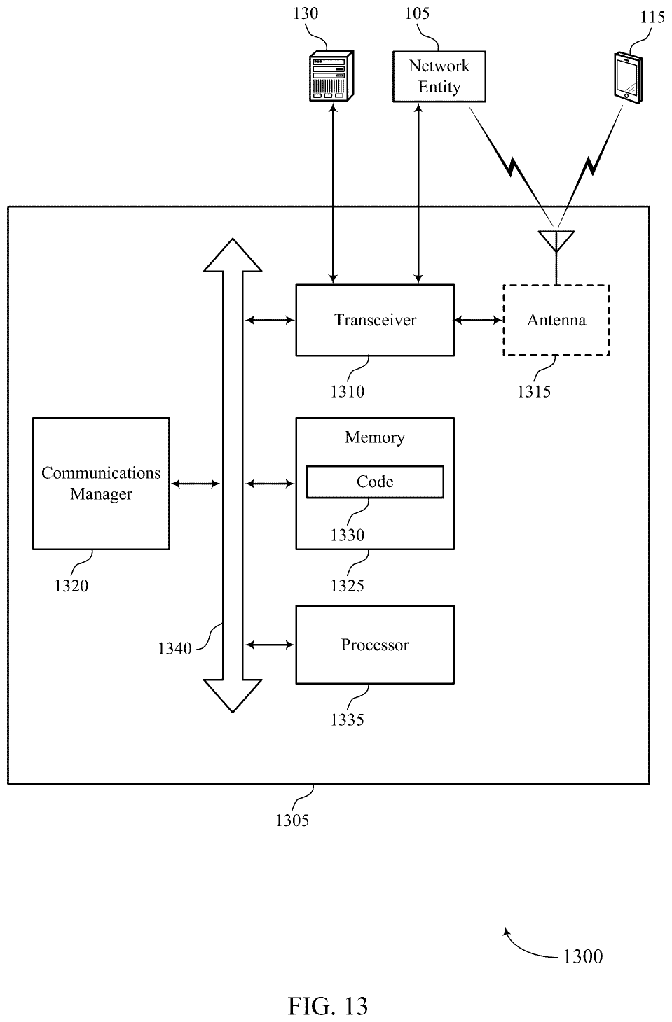

FIG. 13 shows a diagram of a system 1300 including a device 1305 that supports encoders and decoders for vector compression in accordance with one or more aspects of the present disclosure. The device 1305 may be an example of or include the components of a device 1005, a device 1105, or a second wireless device as described herein. The device 1305 may include components for bi-directional voice and data communications including components for transmitting and receiving communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting encoders and decoders for vector compression). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. As such, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

For example, the communications manager 1320 is capable of, configured to, or operable to support a means for communicating an indication of a dependency order for compression of a set of vectors, the dependency order being associated with a compression sequence for the set of vectors. The communications manager 1320 is capable of, configured to, or operable to support a means for receiving a set of compressed vectors that is based on the set of vectors. The communications manager 1320 is capable of, configured to, or operable to support a means for decoding the set of compressed vectors based on the dependency order and the compression sequence to generate a set of decompressed vectors respectively corresponding to the set of vectors.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of encoders and decoders for vector compression as described herein, or the at least one processor 1335 and the at least one memory 1325 may be otherwise configured to, individually or collectively, perform or support such operations.

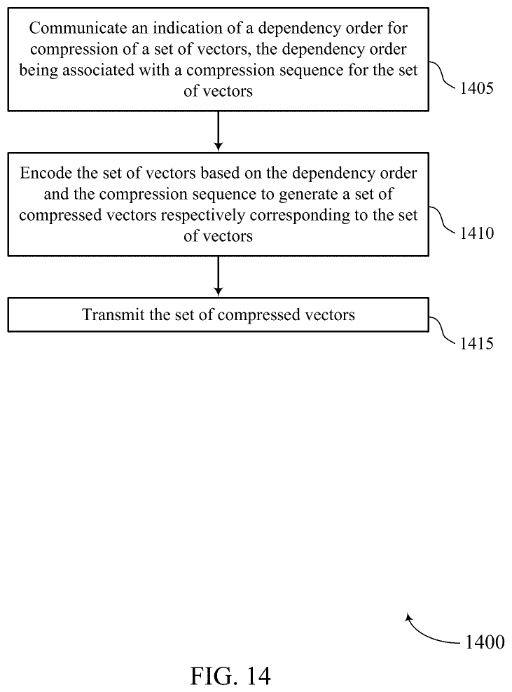

FIG. 14 shows a flowchart illustrating a method 1400 that supports encoders and decoders for vector compression in accordance with aspects of the present disclosure. The operations of the method 1400 may be implemented by a first wireless device or its components as described herein. For example, the operations of the method 1400 may be performed by a first wireless device as described with reference to FIGS. 1 through 9. In some examples, a first wireless device may execute a set of instructions to control the functional elements of the first wireless device to perform the described functions. Additionally, or alternatively, the first wireless device may perform aspects of the described functions using special-purpose hardware.

At 1405, the method may include communicating an indication of a dependency order for compression of a set of vectors, the dependency order being associated with a compression sequence for the set of vectors. The operations of block 1405 may be performed in accordance with examples as disclosed herein. In some examples, aspects of the operations of 1405 may be performed by a dependency order component 825 as described with reference to FIG. 8.

At 1410, the method may include encoding the set of vectors based on the dependency order and the compression sequence to generate a set of compressed vectors respectively corresponding to the set of vectors. The operations of block 1410 may be performed in accordance with examples as disclosed herein. In some examples, aspects of the operations of 1410 may be performed by an encoder component 830 as described with reference to FIG. 8.

At 1415, the method may include transmitting the set of compressed vectors. The operations of block 1415 may be performed in accordance with examples as disclosed herein. In some examples, aspects of the operations of 1415 may be performed by a vector component 835 as described with reference to FIG. 8.

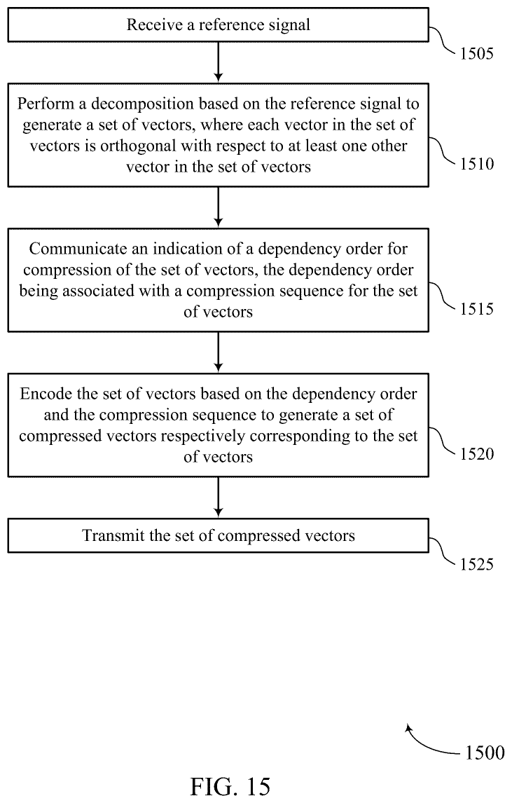

FIG. 15 shows a flowchart illustrating a method 1500 that supports encoders and decoders for vector compression in accordance with aspects of the present disclosure. The operations of the method 1500 may be implemented by a first wireless device or its components as described herein. For example, the operations of the method 1500 may be performed by a first wireless device as described with reference to FIGS. 1 through 9. In some examples, a first wireless device may execute a set of instructions to control the functional elements of the first wireless device to perform the described functions. Additionally, or alternatively, the first wireless device may perform aspects of the described functions using special-purpose hardware.

At 1505, the method may include receiving a reference signal. The operations of block 1505 may be performed in accordance with examples as disclosed herein. In some examples, aspects of the operations of 1505 may be performed by a reference signal component 840 as described with reference to FIG. 8.

At 1510, the method may include performing a decomposition based on the reference signal to generate a set of vectors, where each vector in the set of vectors is orthogonal with respect to at least one other vector in the set of vectors. The operations of block 1510 may be performed in accordance with examples as disclosed herein. In some examples, aspects of the operations of 1510 may be performed by a decomposition component 845 as described with reference to FIG. 8.

At 1515, the method may include communicating an indication of a dependency order for compression of the set of vectors, the dependency order being associated with a compression sequence for the set of vectors. The operations of block 1515 may be performed in accordance with examples as disclosed herein. In some examples, aspects of the operations of 1515 may be performed by a dependency order component 825 as described with reference to FIG. 8.

At 1520, the method may include encoding the set of vectors based on the dependency order and the compression sequence to generate a set of compressed vectors respectively corresponding to the set of vectors. The operations of block 1520 may be performed in accordance with examples as disclosed herein. In some examples, aspects of the operations of 1520 may be performed by an encoder component 830 as described with reference to FIG. 8.

At 1525, the method may include transmitting the set of compressed vectors. The operations of block 1525 may be performed in accordance with examples as disclosed herein. In some examples, aspects of the operations of 1525 may be performed by a vector component 835 as described with reference to FIG. 8.

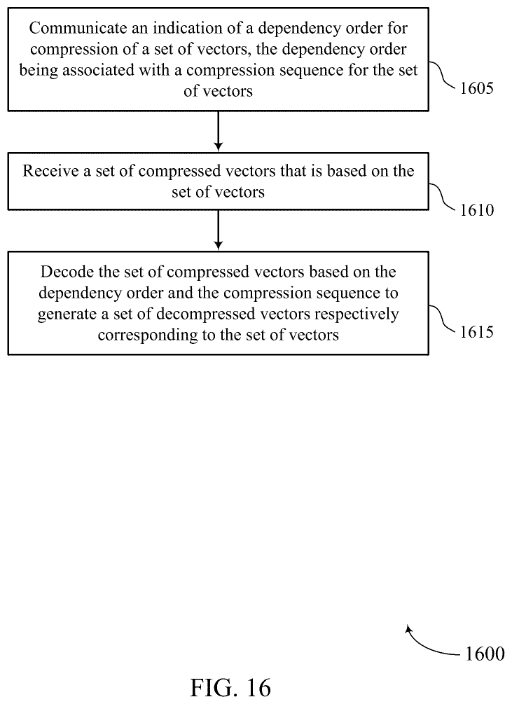

FIG. 16 shows a flowchart illustrating a method 1600 that supports encoders and decoders for vector compression in accordance with aspects of the present disclosure. The operations of the method 1600 may be implemented by a second wireless device or its components as described herein. For example, the operations of the method 1600 may be performed by a second wireless device as described with reference to FIGS. 1 through 5 and 10 through 13. In some examples, a second wireless device may execute a set of instructions to control the functional elements of the second wireless device to perform the described functions. Additionally, or alternatively, the second wireless device may perform aspects of the described functions using special-purpose hardware.

At 1605, the method may include communicating an indication of a dependency order for compression of a set of vectors, the dependency order being associated with a compression sequence for the set of vectors. The operations of block 1605 may be performed in accordance with examples as disclosed herein. In some examples, aspects of the operations of 1605 may be performed by a dependency order manager 1225 as described with reference to FIG. 12.

At 1610, the method may include receiving a set of compressed vectors that is based on the set of vectors. The operations of block 1610 may be performed in accordance with examples as disclosed herein. In some examples, aspects of the operations of 1610 may be performed by a vector manager 1230 as described with reference to FIG. 12.

At 1615, the method may include decoding the set of compressed vectors based on the dependency order and the compression sequence to generate a set of decompressed vectors respectively corresponding to the set of vectors. The operations of block 1615 may be performed in accordance with examples as disclosed herein. In some examples, aspects of the operations of 1615 may be performed by a decoder manager 1235 as described with reference to FIG. 12.

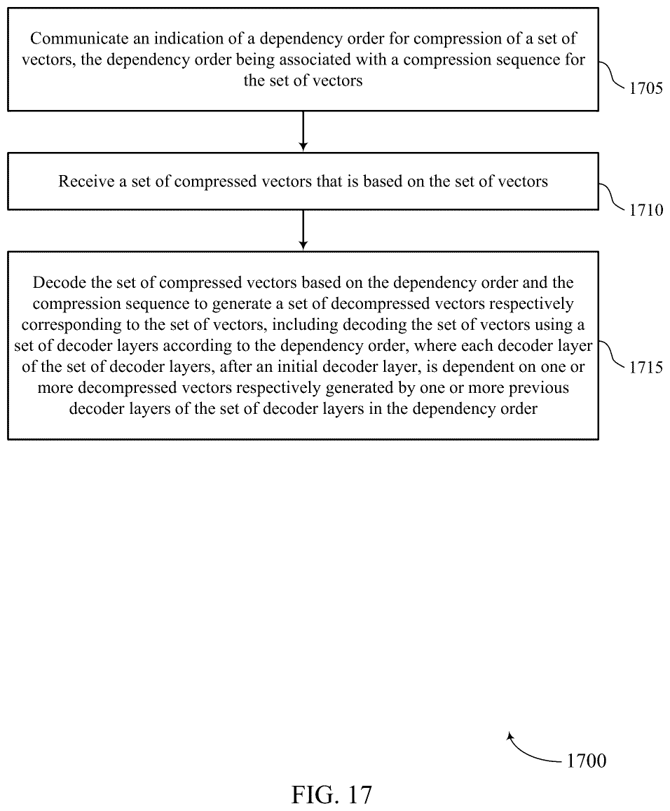

FIG. 17 shows a flowchart illustrating a method 1700 that supports encoders and decoders for vector compression in accordance with aspects of the present disclosure. The operations of the method 1700 may be implemented by a second wireless device or its components as described herein. For example, the operations of the method 1700 may be performed by a second wireless device as described with reference to FIGS. 1 through 5 and 10 through 13. In some examples, a second wireless device may execute a set of instructions to control the functional elements of the second wireless device to perform the described functions. Additionally, or alternatively, the second wireless device may perform aspects of the described functions using special-purpose hardware.

At 1705, the method may include communicating an indication of a dependency order for compression of a set of vectors, the dependency order being associated with a compression sequence for the set of vectors. The operations of block 1705 may be performed in accordance with examples as disclosed herein. In some examples, aspects of the operations of 1705 may be performed by a dependency order manager 1225 as described with reference to FIG. 12.

At 1710, the method may include receiving a set of compressed vectors that is based on the set of vectors. The operations of block 1710 may be performed in accordance with examples as disclosed herein. In some examples, aspects of the operations of 1710 may be performed by a vector manager 1230 as described with reference to FIG. 12.

At 1715, the method may include decoding the set of compressed vectors based on the dependency order and the compression sequence to generate a set of decompressed vectors respectively corresponding to the set of vectors, including decoding the set of vectors using a set of decoder layers according to the dependency order, where each decoder layer of the set of decoder layers, after an initial decoder layer, is dependent on one or more decompressed vectors respectively generated by one or more previous decoder layers of the set of decoder layers in the dependency order. The operations of block 1715 may be performed in accordance with examples as disclosed herein. In some examples, aspects of the operations of 1715 may be performed by a decoder manager 1235 as described with reference to FIG. 12.

The following provides an overview of aspects of the present disclosure:

Aspect 1: A method for wireless communications at a first wireless device, comprising: communicating an indication of a dependency order for compression of a set of vectors, the dependency order being associated with a compression sequence for the set of vectors; encoding the set of vectors based at least in part on the dependency order and the compression sequence to generate a set of compressed vectors respectively corresponding to the set of vectors; and transmitting the set of compressed vectors.

Aspect 2: The method of aspect 1, wherein communicating the indication of the dependency order comprises: transmitting the indication of the dependency order to a second wireless device in a message with the set of compressed vectors or in a message separate from the set of compressed vectors that is transmitted with a same periodicity or a different periodicity as the set of compressed vectors.

Aspect 3: The method of aspect 1, wherein communicating the indication of the dependency order comprises: receiving the indication of the dependency order from a second wireless device for configuring the first wireless device with the dependency order.

Aspect 4: The method of any of aspects 1 through 3, wherein the indication of the dependency order for compression indicates at least one operational dependency in a set of encoder layers of the first wireless device or at least one operational dependency in a set of decoder layers of a second wireless device.

Aspect 5: The method of any of aspects 1 through 4, wherein encoding the set of vectors comprises: encoding the set of vectors using a set of encoder layers according to the dependency order, wherein each encoder layer of the set of encoder layers, after an initial encoder layer, is dependent on one or more compressed vectors respectively generated by one or more previous encoder layers of the set of encoder layers in the dependency order.

Aspect 6: The method of aspect 5, wherein encoding the set of vectors comprises: encoding a first vector of the set of vectors using a first encoder layer of the set of encoder layers to generate a first compressed vector of the set of compressed vectors; and encoding, based at least in part on the first compressed vector, a second vector of the set of vectors using a second encoder layer of the set of encoder layers, wherein the second encoder layer operates after the first encoder layer in the compression sequence, and wherein the second encoder layer is dependent on the first compressed vector generated by the first encoder layer in the dependency order.

Aspect 7: The method of any of aspects 1 through 6, wherein encoding the set of vectors comprises: encoding each vector of the set of vectors using a respective neural network layer of a set of neural network layers.

Aspect 8: The method of aspect 7, wherein the set of neural network layers is trained to generate compressed vectors in the set of compressed vectors that satisfy an orthogonality condition.

Aspect 9: The method of any of aspects 1 through 8, further comprising: receiving a reference signal; and performing a decomposition based at least in part on the reference signal to generate the set of vectors, wherein each vector in the set of vectors is orthogonal with respect to at least one other vector in the set of vectors.

Aspect 10: A method for wireless communications at a second wireless device, comprising: communicating an indication of a dependency order for compression of a set of vectors, the dependency order being associated with a compression sequence for the set of vectors; receiving a set of compressed vectors that is based at least in part on the set of vectors; and decoding the set of compressed vectors based at least in part on the dependency order and the compression sequence to generate a set of decompressed vectors respectively corresponding to the set of vectors.

Aspect 11: The method of aspect 10, wherein communicating the indication of the dependency order comprises: receiving the indication of the dependency order from a first wireless device in a message with the set of compressed vectors or in a message separate from the set of compressed vectors that is received with a same periodicity or a different periodicity as the set of compressed vectors.

Aspect 12: The method of aspect 10, wherein communicating the indication of the dependency order comprises: transmitting the indication of the dependency order to a first wireless device for configuring the first wireless device with the dependency order.

Aspect 13: The method of any of aspects 10 through 12, wherein the indication of the dependency order for compression indicates at least one operational dependency in a set of encoder layers of a first wireless device or at least one operational dependency in a set of decoder layers of the second wireless device.

Aspect 14: The method of any of aspects 10 through 13, wherein decoding the set of vectors comprises: decoding the set of vectors using a set of decoder layers according to the dependency order, wherein each decoder layer of the set of decoder layers, after an initial decoder layer, is dependent on one or more decompressed vectors respectively generated by one or more previous decoder layers of the set of decoder layers in the dependency order.

Aspect 15: The method of aspect 14, wherein decoding the set of vectors comprises: decoding a first compressed vector of the set of compressed vectors using a first decoder layer of the set of decoder layers to generate a first decompressed vector of the set of decompressed vectors; and decoding, based at least in part on the first decompressed vector, a second decompressed vector of the set of decompressed vectors using a second decoder layer of the set of decoder layers, wherein the second decoder layer operates after the first decoder layer in the compression sequence, and wherein the second decoder layer is dependent on the first decompressed vector generated by the first decoder layer in the dependency order.

Aspect 16: The method of any of aspects 10 through 15, wherein decoding the set of vectors comprises: decoding each compressed vector of the set of compressed vectors using a respective neural network layer of a set of neural network layers.

Aspect 17: The method of aspect 16, wherein the set of neural network layers is trained to generate decompressed vectors in the set of decompressed vectors that satisfy an orthogonality condition.

Aspect 18: A first wireless device comprising one or more memories storing processor-executable code, and one or more processors coupled with the one or more memories and individually or collectively operable to execute the code to cause the first wireless device to perform a method of any of aspects 1 through 9.

Aspect 19: A first wireless device comprising at least one means for performing a method of any of aspects 1 through 9.

Aspect 20: A non-transitory computer-readable medium storing code the code comprising instructions executable by a processor to perform a method of any of aspects 1 through 9.

Aspect 21: A second wireless device comprising one or more memories storing processor-executable code, and one or more processors coupled with the one or more memories and individually or collectively operable to execute the code to cause the second wireless device to perform a method of any of aspects 10 through 17.

Aspect 22: A second wireless device comprising at least one means for performing a method of any of aspects 10 through 17.

Aspect 23: A non-transitory computer-readable medium storing code the code comprising instructions executable by a processor to perform a method of any of aspects 10 through 17.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device, comprising:
one or more memories storing processor-executable code; and
one or more processors coupled with the one or more memories and individually or collectively operable to execute the code to cause the first wireless device to:
communicate an indication of a dependency order for compression of a set of vectors, the dependency order being associated with a compression sequence for the set of vectors;
encode the set of vectors based at least in part on the dependency order and the compression sequence to generate a set of compressed vectors respectively corresponding to the set of vectors; and
transmit the set of compressed vectors.

2. The first wireless device of claim 1, wherein, to communicate the indication of the dependency order, the one or more processors are individually or collectively operable to execute the code to cause the first wireless device to:
transmit the indication of the dependency order to a second wireless device in a message with the set of compressed vectors or in a message separate from the set of compressed vectors that is transmitted with a same periodicity or a different periodicity as the set of compressed vectors.

3. The first wireless device of claim 1, wherein, to communicate the indication of the dependency order, the one or more processors are individually or collectively operable to execute the code to cause the first wireless device to:
receive the indication of the dependency order from a second wireless device for configuring the first wireless device with the dependency order.

4. The first wireless device of claim 1, wherein the indication of the dependency order for compression indicates at least one operational dependency in a set of encoder layers of the first wireless device or at least one operational dependency in a set of decoder layers of a second wireless device.

5. The first wireless device of claim 1, wherein, to encode the set of vectors, the one or more processors are individually or collectively operable to execute the code to cause the first wireless device to:
encode the set of vectors using a set of encoder layers according to the dependency order, wherein each encoder layer of the set of encoder layers, after an initial encoder layer, is dependent on one or more compressed vectors respectively generated by one or more previous encoder layers of the set of encoder layers in the dependency order.

6. The first wireless device of claim 5, wherein, to encode the set of vectors, the one or more processors are individually or collectively operable to execute the code to cause the first wireless device to:
encode a first vector of the set of vectors using a first encoder layer of the set of encoder layers to generate a first compressed vector of the set of compressed vectors; and
encode, based at least in part on the first compressed vector, a second vector of the set of vectors using a second encoder layer of the set of encoder layers, wherein the second encoder layer operates after the first encoder layer in the compression sequence, and wherein the second encoder layer is dependent on the first compressed vector generated by the first encoder layer in the dependency order.

7. The first wireless device of claim 1, wherein, to encode the set of vectors, the one or more processors are individually or collectively operable to execute the code to cause the first wireless device to:
encode each vector of the set of vectors using a respective neural network layer of a set of neural network layers.

8. The first wireless device of claim 7, wherein the set of neural network layers is trained to generate compressed vectors in the set of compressed vectors that satisfy an orthogonality condition.

9. The first wireless device of claim 1, wherein the one or more processors are individually or collectively further operable to execute the code to cause the first wireless device to:
receive a reference signal; and
perform a decomposition based at least in part on the reference signal to generate the set of vectors, wherein each vector in the set of vectors is orthogonal with respect to at least one other vector in the set of vectors.

10. A second wireless device, comprising:
one or more memories storing processor-executable code; and
one or more processors coupled with the one or more memories and individually or collectively operable to execute the code to cause the second wireless device to:
communicate an indication of a dependency order for compression of a set of vectors, the dependency order being associated with a compression sequence for the set of vectors;
receive a set of compressed vectors that is based at least in part on the set of vectors; and
decode the set of compressed vectors based at least in part on the dependency order and the compression sequence to generate a set of decompressed vectors respectively corresponding to the set of vectors.

11. The second wireless device of claim 10, wherein, to communicate the indication of the dependency order, the one or more processors are individually or collectively operable to execute the code to cause the second wireless device to:
receive the indication of the dependency order from a first wireless device in a message with the set of compressed vectors or in a message separate from the set of compressed vectors that is received with a same periodicity or a different periodicity as the set of compressed vectors.

12. The second wireless device of claim 10, wherein, to communicate the indication of the dependency order, the one or more processors are individually or collectively operable to execute the code to cause the second wireless device to:
transmit the indication of the dependency order to a first wireless device for configuring the first wireless device with the dependency order.

13. The second wireless device of claim 10, wherein the indication of the dependency order for compression indicates at least one operational dependency in a set of encoder layers of a first wireless device or at least one operational dependency in a set of decoder layers of the second wireless device.

14. The second wireless device of claim 10, wherein, to decode the set of vectors, the one or more processors are individually or collectively operable to execute the code to cause the second wireless device to:
decode the set of vectors using a set of decoder layers according to the dependency order, wherein each decoder layer of the set of decoder layers, after an initial decoder layer, is dependent on one or more decompressed vectors respectively generated by one or more previous decoder layers of the set of decoder layers in the dependency order.

15. The second wireless device of claim 14, wherein, to decode the set of vectors, the one or more processors are individually or collectively operable to execute the code to cause the second wireless device to:
decode a first compressed vector of the set of compressed vectors using a first decoder layer of the set of decoder layers to generate a first decompressed vector of the set of decompressed vectors; and
decode, based at least in part on the first decompressed vector, a second decompressed vector of the set of decompressed vectors using a second decoder layer of the set of decoder layers, wherein the second decoder layer operates after the first decoder layer in the compression sequence, and wherein the second decoder layer is dependent on the first decompressed vector generated by the first decoder layer in the dependency order.

16. The second wireless device of claim 10, wherein, to decode the set of vectors, the one or more processors are individually or collectively operable to execute the code to cause the second wireless device to:
decode each compressed vector of the set of compressed vectors using a respective neural network layer of a set of neural network layers.

17. The second wireless device of claim 16, wherein the set of neural network layers is trained to generate decompressed vectors in the set of decompressed vectors that satisfy an orthogonality condition.

18. A method for wireless communications at a first wireless device, comprising:
communicating an indication of a dependency order for compression of a set of vectors, the dependency order being associated with a compression sequence for the set of vectors;
encoding the set of vectors based at least in part on the dependency order and the compression sequence to generate a set of compressed vectors respectively corresponding to the set of vectors; and
transmitting the set of compressed vectors.

19. The method of claim 18, wherein communicating the indication of the dependency order comprises:
transmitting the indication of the dependency order to a second wireless device in a message with the set of compressed vectors or in a message separate from the set of compressed vectors that is transmitted with a same periodicity or a different periodicity as the set of compressed vectors.

20. The method of claim 18, wherein communicating the indication of the dependency order comprises:
receiving the indication of the dependency order from a second wireless device for configuring the first wireless device with the dependency order.
